(19) United States
(12) Patent Application Publication
(10) Pub. No.: US 2026/0147078 A1
(43) Pub. Date: May 28, 2026

(54) METHODS, ARCHITECTURES, APPARATUSES, AND SYSTEMS FOR SENSING-ASSISTED POSITIONING

(71) Applicant: InterDigital Patent Holdings, Inc., Wilmington, DE (US)

(72) Inventors: Yasser Mestrah, Uxbridge (GB); Ghyslain Pelletier, Montreal (CA); Ibrahim Hemadeh, London (GB); Mohammad Heggo, Lewisham (GB); Arman Shojaeifard, London (GB); Fumihiro Hasegawa, Westmount (CA); Moon IL Lee; Paul Marinier, Brossard (CA)

(21) Appl. No.: 18/963,335

(22) Filed: Nov. 27, 2024

(51) Int. Cl. G01S 5/02; G01S 7/00; G01S 13/86

(52) U.S. Cl. CPC G01S 5/0236; G01S 7/006; G01S 13/86

(57) ABSTRACT

Methods and devices are provided for sensing-assisted positioning. A wireless transmit/receive unit (WTRU) receives configuration information from a wireless network to assist in a positioning operation. The WTRU performs positioning measurements and identifies events that trigger sensing-related actions. Upon detecting such an event, the WTRU executes these actions and conducts additional positioning measurements. Events triggering these actions can include changes in measurements, error types, or mobility of the WTRU. The configuration information may include details like target identifiers and positioning information. The WTRU can also transmit assistance information to the network and receive updates, repeating the process until a termination event is detected. Sensing-related actions may involve improving line of sight detection, clutter removal, and performing sensing measurements. The method ensures accurate and reliable positioning and sensing by dynamically adapting to detected events and updating measurements accordingly.

### TECHNICAL FIELD

The present disclosure is generally directed to the fields of communications, software and encoding, including, for example, to methods, architectures, apparatuses, systems related to integrated sensing and communication (ISAC) (e.g., detecting a target object based on configuration of at least one of a wireless transmit/receive unit or a wireless network).

### BACKGROUND

A device (e.g., a wireless transmit/receive unit) that is communicatively coupled to a wireless network may perform positioning-related measurements based on signals from the wireless network. During this process, positioning measurement errors caused by sensing performance may occur.

### SUMMARY

In certain representative embodiments, methods and wireless transmit/receive units (WTRUs) are provided for sensing-assisted positioning. For example, the WTRU receives configuration information from a wireless network. Also, for example, the configuration information relates to a positioning operation and identifies at least one event that triggers sensing-related actions to assist the positioning operation. Further, for example, the WTRU performs positioning measurements based on this information. In addition, for example, if an event occurs during these measurements, the WTRU performs the sensing-related actions and then conducts additional positioning measurements based on these actions.

Moreover, for example, the event is triggered by various factors, such as changes in positioning measurements, hierarchical measurement dependencies, determined error types or sources, reference or expected values of the measurements, the reliability of the measurements, determined lack of neighboring cells or loss of line of sight, determined variation in channel response, determined positioning requirements not being satisfied, or the mobility of the WTRU.

Furthermore, for example, the information related to the positioning operation includes a target identifier, positioning information, target type, mobility information, WTRU positioning information, hierarchical measurements and dependencies, error sources, error types, error groups, reference positioning measurements, thresholds for validation, reporting assistance information, or a validity time.

Additionally, for example, the WTRU transmits assistance information to the wireless network based on the positioning measurements, receives updated assistance information, and repeats one or more of the process steps if no termination event is detected. Still further, for example, if a termination event is detected, the WTRU transmits a report based on the positioning measurements.

Even further, for example, the sensing-related actions involve performing sensing measurements, identifying alternate paths or reference signals to measure, estimating expected duration of an error state, estimating and reporting WTRU position, improving line of sight detection and clutter removal, validating sensing measurements, reporting sensing measurements, or determining reporting modes based on the event.

Yet further, for example, the event triggers positioning-related actions to assist the sensing operation. Further still, for example, the positioning-related actions include sending uplink assistance information to the wireless network, logging positioning measurements, stopping radio access technology (RAT) based positioning, applying non RAT-based positioning, enabling new positioning measurements, validating positioning measurements, reporting positioning measurements, or determining reporting modes based on the event.

Also, for example, the configuration information indicates information related to a sensing operation, leading the WTRU to perform sensing measurements based on this information. Further, for example, the occurrence of an event is determined based on these sensing measurements. In addition, for example, the configuration information identifies events that trigger positioning-related actions to assist the sensing operation. Moreover, for example, if an additional event occurs during sensing measurements, the WTRU performs positioning-related actions and additional sensing measurements based on these actions.

Additionally, for example, the WTRU receives, form the wireless network, updated configuration information indicating updated information related to the positioning operation and performs additional positioning measurements based on the updated information (e.g., and the sensing-related actions).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating the impact of sensing in improving positioning measurements, according to one or more embodiments;

FIG. 3 is a chart of an example positioning-assisted sensing procedure, according to one or more embodiments;

FIG. 4 is a chart illustrating an example first WTRU procedure that triggers a second WTRU procedure, according to one or more embodiments;

FIG. 5 is a chart illustrating an example of downlink (DL) signaling for WTRU configuration in sensing and positioning under unified network control, according to one or more embodiments;

FIG. 6 is a chart illustrating an example of DL signaling for WTRU configuration in sensing and positioning under separate network control, according to one or more embodiments;

FIG. 7 is a diagram illustrating an example of channel impulse response (CIR) behavior for sensing and positioning using common reference signals (RSs), according to one or more embodiments;

FIG. 8 is a diagram illustrating an example of CIR behavior for sensing and positioning using separate RSs, according to one or more embodiments;

FIG. 9 is a diagram of hierarchal measurement dependency within and between WTRU procedures, according to one or more embodiments;

FIG. 10 is a diagram of error determination using a single measurement or multiple measurements, according to one or more embodiments;

FIG. 11 is a diagram of error detection using a single measurement, according to one or more embodiments;

FIG. 12 is a diagram of different sensing and positioning reporting modes, according to one or more embodiments;

FIG. 13 is a chart illustrating an example positioning-assisted sensing procedure using multiple WTRUs and separate network entities to perform sensing and positioning, according to one or more embodiments; and

FIG. 14 is a chart illustrating sample systems and methods for performing sensing-assisted positioning, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

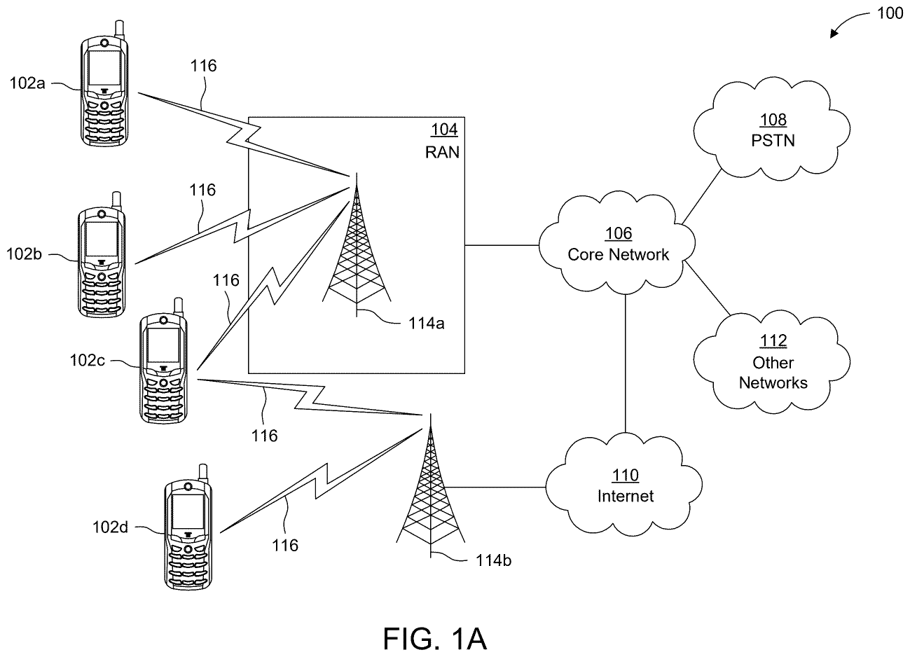

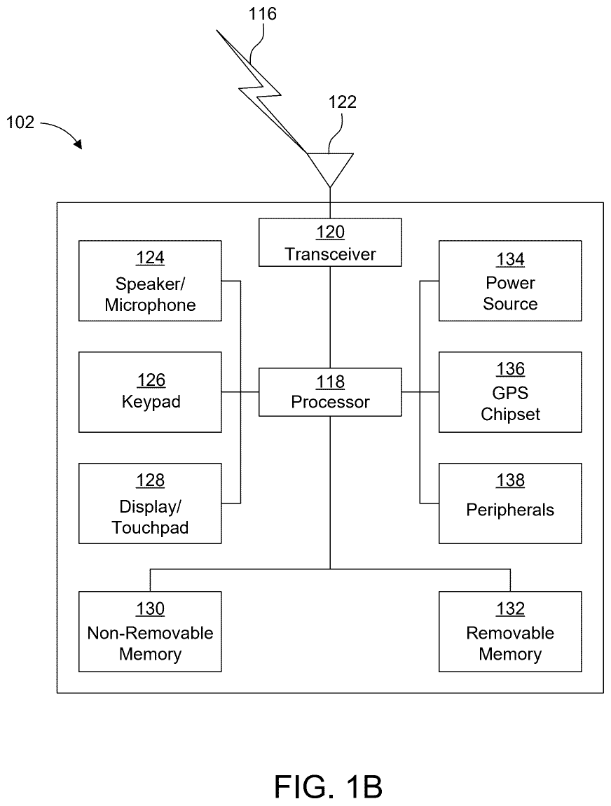

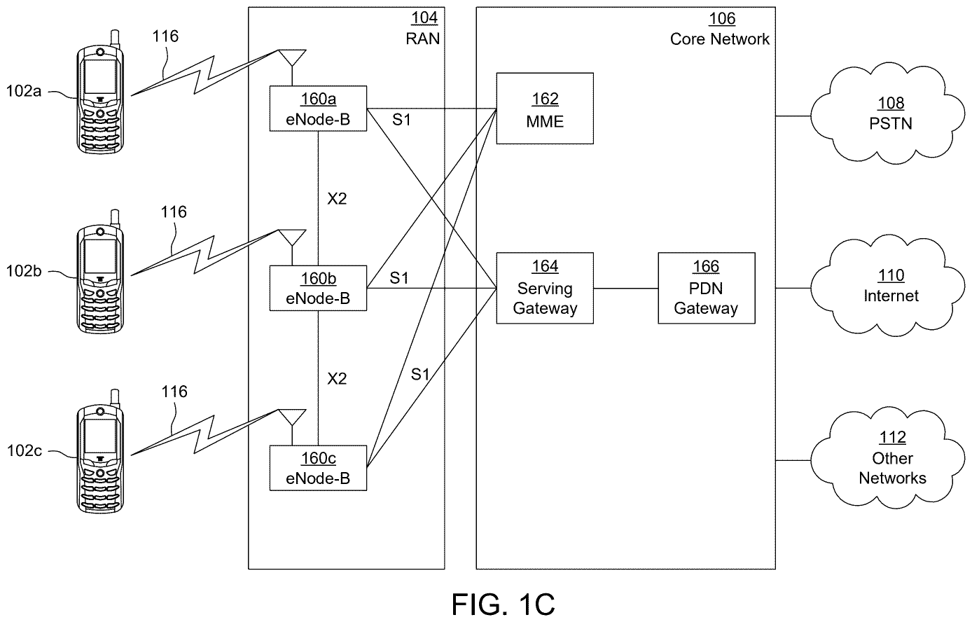

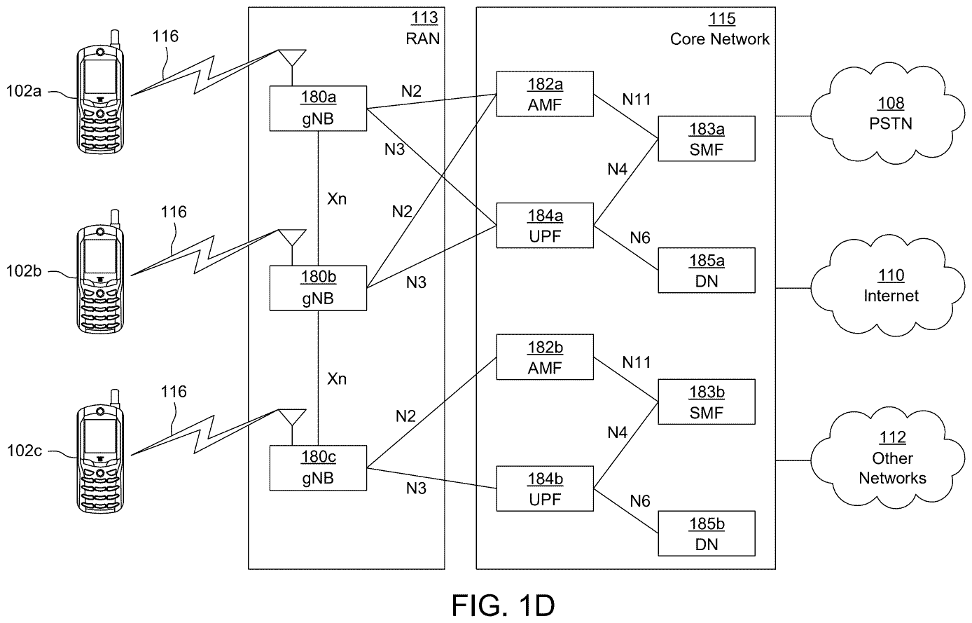

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations (BSs), networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home cNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). The frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the cNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of the elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of the component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of the elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, cNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some approaches, next generation cellular systems (e.g., 5^{th} generation (5G), 5G advance, 6^{th} generation (6G), or the like) utilize higher frequency bands (e.g., mmWave to THz), wider bandwidth, and massive antenna arrays to enable high-accuracy and high-resolution sensing. In such approaches (e.g., ISAC), wireless signal sensing and communication may be integrated into a single system, providing benefits to both functions. For example, the entire communications network may function as a giant sensor, using both transmitted and received radio signals, along with their reflections and scattering, to better understand the physical world. Further, for example, such approaches may extract range, velocity, and angle information from radio signals to enable a wide array of new services, such as high-accuracy localization or positioning.

For example, these networks may demand sub-centimeter level positioning techniques, requiring the detailed understanding of the radio signal propagation environment provided by sensing. Further, for example, the position of the WTRU may be determined from sensing measurement parameters by mapping the radio frequency (RF) environment and understanding how the transmitted waveform is altered. Such approaches may leverage the multipath nature of the propagation channel and exploit sensing information to improve the reliability and accuracy of positioning results. Moreover, for example, sensing-assisted positioning may be enhanced by higher frequency signaling due to the sparser channels that enable easier characterization of the relationship between the WTRU positioning and its propagation channel. Due to the underlying interdependencies between sensing and positioning in modern WTRU communication systems, systems and methods for coordinating the frameworks for positioning and sensing (e.g., positioning-assisted sensing, sensing-assisted positioning) are provided to mutually enhance both operations.

Accordingly, methods, architectures, apparatuses, and systems for assisting a positioning operation with sensing-related actions are provided. For example, methods and systems are provided for WTRU detection and reporting of positioning measurement error that depends on and/or is caused by sensing performance. Also, for example, WTRU behaviors are provided, to improve sensing measurement accuracy and reliability. Further, for example, the WTRU reports sensing in addition to positioning measurements and a validity window.

For example, in accordance with ISAC, systems and methods for positioning, sensing, error source type determination, and/or validating measurement integrity are provided. Also, for example, the WTRU receives a positioning configuration with events (e.g., including conditions) that are triggers for sensing actions, including conditions for reporting, update, and termination procedure. Further, for example, the WTRU receives reference signal(s) and performs set of configured measurements. In addition, for example, the WTRU determines error type(s) and source(s) based on positioning and/or sensing measurements. Moreover, the WTRU processes and/or monitors and/or determines event triggers (e.g., for positioning) using sensing and/or positioning measurements. Furthermore, for example, the WTRU performs set of actions towards improving positioning performance (e.g., by improving sensing accuracy). Additionally, for example, the WTRU reports to the network sensing measurements in addition to positioning measurements and a validity window.

For example, sensing-assisted positioning (e.g., coordination of simultaneous sensing and positioning operations) is described as follows. Moreover, for example, a WTRU receives, from a wireless network, configuration information indicating information related to a positioning operation and/or identifying events that trigger sensing-related actions to assist the positioning operation. Further, for example, the WTRU performs positioning measurements based on the information related to the positioning operation. Additionally, for example, the WTRU determines that an event (e.g., that triggers the sensing-related actions) has occurred while performing the positioning measurements. Also, for example, the WTRU, based on determining that the event has occurred, performs the sensing-related actions. Furthermore, for example, the WTRU performs additional positioning measurements (e.g., related to the positioning operation) based on performing the sensing-related actions.

For example, in combination with sensing-assisted positioning, new radio (NR) sensing of targets in the environment is described as follows. Further, for example, the NR sensing includes detecting, estimating, and monitoring conditions (e.g., shape, size, orientation, speed, location, distance, relative motion, or the like) of the environment and/or objects within the environment using NR radio frequency (RF) signals. Additionally, for example, next generation technologies (e.g., 5G advance, 6G) enable highly accurate sensing with high resolution relevant information extraction through high carrier frequencies, large available bandwidth, large number of antennas, device-to-device communications, network densification and/or artificial intelligence/machine learning (AI/ML). Also, for example, NR sensing is categorized into monostatic and bistatic sensing modes based on the transmitter and receiver location. Moreover, for example, channel models for NR sensing and ISAC are defined for object detection and tracking. NR sensing can be viewed as an extension of NR positioning. The reference signals, architectures, signaling frameworks, methods, and protocols defined for positioning may also be applicable to sensing.

For example, in combination with sensing-assisted positioning, NR positioning methods are described as follows. NR positioning methods may differ between DL and UL conditions.

For example, in downlink positioning, positioning reference signal (PRS) resources from multiple transmit-receive points (TRPs) are transmitted to the target WTRU. Further, for example, the signal propagation environment changes some of the properties of the transmitted signal (e.g., signal amplitude, frequency, phase, or the like), which is measured by the WTRU (e.g., as reference signal received power (RSRP), reference signal time difference (RSTD), doppler shifts, or the like). Also, for example, the WTRU, based on the measured properties infers intermediate positioning metrics, e.g., delay between the TRP and the WTRU (e.g., DL-time difference of arrival (TDoA)), angle (e.g., DL-angle of departure (AoD)), combinations of the same, or the like.

For example, in uplink positioning, the sounding reference signal for positioning (SRSp) resources are transmitted by the WTRU to multiple TRPs. Further, for example the TRPs measure each SRSp resource, e.g., to acquire RSRP, RSTD, doppler shift, combinations of the same, or the like. Moreover, for example, the TRPs infer intermediate positioning metrics, e.g., delay between the TRP and the WTRU (e.g., UL-TDoA), angle (e.g., UL-AoA), combinations of the same, or the like.

In some examples, DL and UL positioning are combined such that the TRP transmits the SL-PRS to the WTRU and upon reception of the DL-PRS the WTRU transmits the SRSp. Such approaches may generate a two-way range between the TRP and the target WTRU, eliminating potential TRP-WTRU clock synchronization error issues. In some examples, measurements and metrics at the WTRU or multiple TRPs may be fused together at the WTRU, TRP and/or the network to estimate the location of the target WTRU (e.g., in 2D or 3D coordinates).

For example, in combination with sensing-assisted positioning, NR positioning architectures are described as follows. Further, for example, positioning architecture may include three main entities: the target WTRU, next generation radio access network (NG-RAN) (e.g., including NR gNB, long-term evolution (LTE) NG-CNB TRPs, or the like), and the core network (e.g., 5G core (5GC) including the access mobility function (AMF) and/or location management function (LMF)). Further for example, each of the three entities may assume a role based on whether the positioning is WTRU-based or WTRU-assisted. These roles may include at least one of: requesting and/or transmitting positioning assistance information, requesting and/or transmitting DL-PRS and/or UL-SRS resources, measuring and/or transmitting positioning metrics, measuring and/or transmitting final position estimates, combinations of the same, or the like.

For example, in combination with sensing-assisted positioning, NR positioning protocols are described as follows. Further, for example, interfaces over which messages are transmitted to the different entities include: the next generation control plane (NG-C) interface (e.g., connecting the NG-RAN and the core network); the NR/LTE Uu interface (e.g., connecting the WTRU and the NG-RAN); or the like. Moreover, different signaling protocols for exchanging positioning information and measurements between the entities include: the NR physical resource block (PRB) and path assignment (NRPPa), e.g., between the NG-RAN and the LMF over NG-C interface; radio resource control (RRC), e.g., between the gNB/NG-cNB and the WTRU over the NR/LTE-Uu interface; LTE positioning protocol (LPP), e.g., between the WTRU and the LMF over the NG-C and NR/LTE-Uu interface; combinations of the same; or the like.

In certain representative embodiments, positioning is configured with sensing-related conditions. For example, methods are provided for sensing triggers as a function of positioning measurements. Also, for example, methods are provided for sensing triggers as a function of determined error sources. Further, for example, methods are provided for sensing triggers as a function of sensing events. In addition, methods are provided for at least one of the sensing triggers as the function of positioning measurements, the sensing triggers as the function of determined error sources, the sensing triggers as a function of sensing events, combinations of the same, or the like. Moreover, for example, positioning is performed first, and then sensing is triggered.

For example, a WTRU receives configurations for both sensing and positioning. Also, for example, the WTRU receives configurations for positioning, such as measurement configurations, and for sensing, such as measurement triggers. Further, for example, configurations can be delivered through control messages over various signaling methods, including RRC, MAC-CE, or DCI.

For example, the positioning configurations may include triggers that affect both sensing and positioning. Also, for example, the WTRU categorizes different types of errors as systematic or random, and identifies their sources, which can be time-based or angle-based.

For example, based on determined triggers, the WTRU performs specific actions, such as sending uplink assistance information, logging measurements, or stopping positioning activities. Also, for example, to improve sensing accuracy, the WTRU may suggest better sensing methods based on the identified error types and sources, and the WTRU can execute joint sensing methods. Further, for example, the WTRU determines reporting modes based on the validity of the positioning and sensing measurements and may trigger reports conditioned by the validation of these measurements. In addition, for example, the WTRU can receive reconfiguration messages to update its sensing and positioning configurations. Moreover, for example, one or more of these steps are repeated by the WTRU until a termination event occurs.

In accordance with certain representative embodiments of the present disclosure, relevant terminology is defined as follows.

Systematic error may refer to a consistent, predictable error that skews measurements away from the true value in a specific direction (e.g., positioning error).

Random error may refer to an unpredictable variation in measurements that causes the measurements to scatter around the true value. For example, random error arises from unpredictable fluctuations in the measurement process (e.g., environmental changes, channel variations, or the like).

Hierarchal measurements may refer to measurements organized in a multi-level structure, where each level represents a different degree of detail or aggregation. For example, hierarchal measurements may take the form of structured rules related to hierarchal measurement events that trigger other events and WTRU behaviors (e.g., reporting). In some examples, a hierarchal structure may define radar cross-section (RCS) for sensing as a secondary measurement to the primary measurement of angle of arrival (AoA). For example, an error in the primary measurements (e.g., AoA) propagates to the secondary measurements (e.g., RCS). However, for example, an error in the secondary measurements (e.g., RCS) may not always indicate a problem in the primary measurements (e.g., AoA). Similarly, for example, a hierarchal structure may define RSTD for positioning as a secondary measurement to the primary measurement of time of arrival (ToA). Moreover, for example, a hierarchal structure may indicate that a measurement has no dependencies.

A “TRP” may be used interchangeably with “gNB” or “PRU” or “sensing transmitter” or a “WTRU.” The term “TRP” may be used to indicate an entity (e.g., RAN entity) capable of transmitting a reference signals (e.g., DL-PRS, synchronization signal burst (SSB), channel state information-reference signal (CSI-RS), or the like).

A “WTRU” may be used interchangeably with “sensing receiver” and “UE” and may be used to indicate an entity (e.g., RAN entity) capable of receiving and measuring reference signals (e.g., DL-PRS, SSB, CSI-RS, or the like).

A “network” or “NW” may refer to the AMF, LMF, gNB, NG-RAN, or any other entity involved in sensing functionalities (e.g., SMF).

A “location” may be used interchangeably with “position.” For example, a “location” (e.g., WTRU location, TRP location, or the like) may be expressed in terms of altitude, latitude, geographic coordinate, local coordinate, combinations of the same, or the like.

A “reference signal” or “RS” may refer to any of the positioning and reference signals, e.g., DL-PRS, SRSp, CSI-RS, demodulation reference signal (DM-RS), SSB, or the like.

A “DL-PRS” may refer to any of the downlink positioning or any other reference signals that may be received and/or measured by the WTRU, e.g., SSB, CSI-RS, or the like.

The WTRU may receive configured thresholds from the network (e.g., LMF, gNB, or the like) via a downlink physical channel (e.g., physical downlink shared channel (PDSCH), physical downlink control channel (PDCCH), or the like) or via lower or higher layer signaling (e.g., downlink control indicator (DCI), medium access control-control element (MAC-CE), RRC or LPP message, or the like).

An LMF is a non-limiting example of a node or entity (e.g., network node or entity) that may be used for or to support positioning and/or sensing. Any other node or entity (e.g., server WTRU, sensing management function) may be substituted for the LMF and still be consistent with this disclosure.

An “ID” may be used interchangeably with “index.”

A “path” may be used interchangeably with “multipath.”

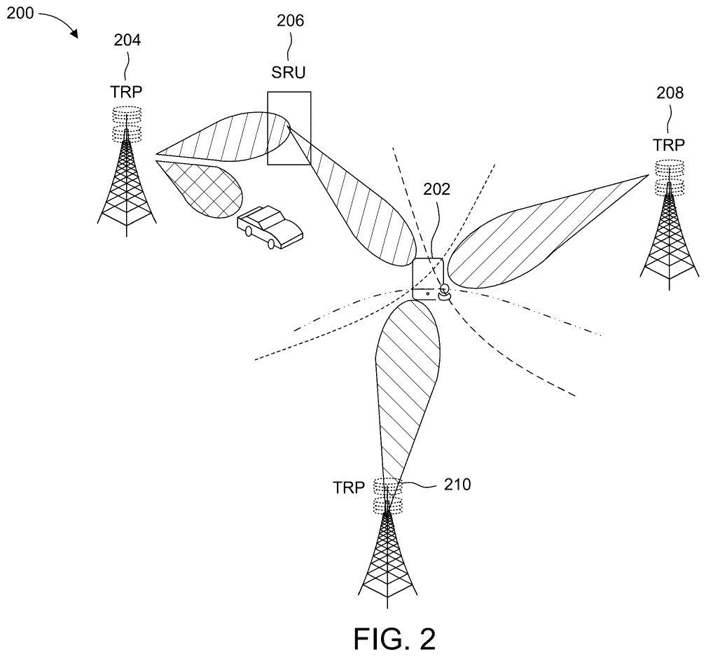

FIG. 2 is a diagram 200 illustrating the impact of sensing in improving positioning measurements, according to one or more embodiments. As shown in FIG. 2, sensing and positioning accuracy and reliability may be interrelated. For example, transmit-receive points (TRPs) 208 and 210 may perform positioning measurements on a WTRU 202. Further, for example, the TRP 204 may perform sensing measurements, e.g., via sensing reference unit (SRU) 206, to assist (e.g., TRPs 208 and 210) in the positioning of the WTRU 202. Moreover, for example, the TRP 204 performing sensing measurements may be based on determining that a line of sight (LOS) path cannot be achieved. In such examples, performing sensing measurements of the target may improve accuracy and reliability of positioning measurements.

For example, in WTRU-assisted sensing, the WTRU is configured to measure and report sensing measurements to the network. Further, for example, in WTRU-assisted positioning, the WTRU is configured to measure and report positioning measurements to the network. However, the positioning may be conditioned on or impacted by sensing, e.g., unreliable sensing measurements, and/or sensing measurements subject to error sources. Thus, WTRU behavior for sensing that is defined as a function of positioning-related WTRU behavior is provided. Accordingly, an example positioning framework that includes events that trigger sensing-related behavior is described herein.

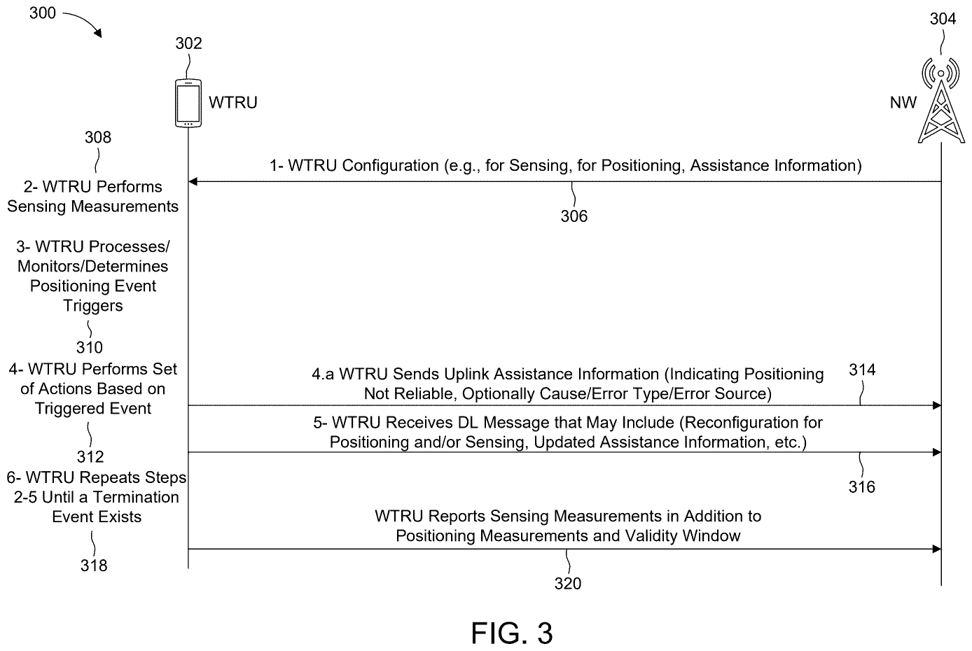

FIG. 3 is a chart 300 of an example sensing-assisted positioning procedure, according to one or more embodiments. As shown in FIG. 3, in certain representative embodiments, the WTRU 302, in connection with network 304, performs positioning and triggers sensing-related actions while performing positioning. For example, the WTRU 302 may trigger sensing-related actions based on at least one of positioning measurements, determined error sources, sensing events, combinations of the same, or the like. Further, for example, the WTRU 302 receives 306 a configuration for positioning (e.g., including a measurement configuration and a measurement object with a measurement ID (measID)) and a configuration for sensing (e.g., including an event trigger that refers to positioning measID). Additionally, for example, the WTRU 302 performs 308 positioning measurements. Also, for example, the WTRU 302 determines 310 an event trigger. Moreover, for example, the WTRU 302 performs 312 one or more actions based on the determined event trigger. Still further, for example, the WTRU 302 may send 314 uplink information to the network 304. Even further, for example, the WTRU 302 may receive 316 a DL message from the network 304 indicating updated assistance or reconfiguration information. The WTRU 302 may repeat 318 one or more of the aforementioned steps until a termination event is determined to exist. Furthermore, for example, the WTRU 320 reports any relevant information (e.g., sensing information, positioning information, or the like) to the network 304.

In certain representative embodiments, the WTRU 302 receives 306 configuration information (e.g., over RRC signaling, MAC-CE, DCI, or the like) including at least one of the following: sensing configuration information, positioning configuration information, positioning assistance information, combinations of the same, or the like. In some examples, the sensing configuration may be a common configuration with positioning to perform both sensing and positioning. In other examples, the WTRU 302 receives 306 a standalone sensing configuration.

For example, the positioning configuration may include measurement configuration information and/or sensing events and/or conditions that are triggers for positioning-related actions. Further, for example, measurement configuration information may include at least one of the following: RSs (e.g., PRS); positioning method; triggers; combinations of the same; or the like. Additionally, for example, sensing events and/or conditions that are triggers for positioning-related actions may impact at least one of: sensing measurements; configuration for sensing; reporting for sensing, e.g., include positioning measurements with sensing measurements; combinations of the same; or the like.

For example, positioning assistance information may include at least one of the following: error types, e.g., systematic, random, or the like; error sources, e.g., time-based, angle-based, channel-based, or the like; error groups, e.g., time error groups; categorization of error sources (e.g., filter based on positioning type) and corresponding distributions; hierarchal measurements and dependencies, e.g., including structured rules related to hierarchal measurement events that trigger other events and reports; positioning measurement references and thresholds for validation, e.g., positioning reference units (PRUs) (e.g., including known location and sensing characteristics), or the like; TRP (e.g., absolute or relative) location (e.g., of the serving gNB, of the neighbor gNBs); WTRU location (e.g., absolute or relative) and valid time window; combinations of the same; or the like.

In certain representative embodiments, the WTRU 302, performs 308 positioning measurements of a RS signal. For example, the WTRU 302 may perform 308 positioning measurements with or without an accompanying sensing measurement. Further, for example, the WTRU 302 may perform 308 positioning measurements for a specific period of time, e.g., based on the configuration information received 306 from the network 304 or based on prior configuration of the WTRU 302.

In certain representative embodiments, the WTRU 302 determines 310 an event trigger (e.g., that triggers a sensing-related action). For example, the WTRU 302 may determine 310 the event trigger based on at least one of the following: a set of measurements (e.g., AoA, ToA, RSRP, reference signal received power per path (RSRPP), or the like); hierarchal measurement dependencies; a determined error type or source; reference values (e.g., PRUs, anchor objects, or the like) and/or expected values (e.g., TRP location, coarse WTRU location, or the like); positioning measurement reliability; positioning measurement triggers (e.g., insufficient neighboring cells for WTRU positioning, blockage/loss of line of sight (LOS) from neighboring cells, CIR variation); positioning reporting triggers, e.g., positioning integrity failed, positioning requirements not satisfied, validation of WTRU location, improving positioning accuracy using sensing measurements; mobility triggers, e.g., measured WTRU velocity above a threshold value or within a range of threshold values; combinations of the same; or the like. For example, the WTRU may determine an event trigger based on determined error type or source using angle measurement error (e.g., low RSRP, RSRPP, or the like) and/or time measurement error (e.g., high synchronization error).

In certain representative embodiments, the WTRU 302 performs 312 one or more actions based on the determined event trigger. For example, the WTRU 302 performs 312 sensing-related actions (e.g., to improve positioning by improving sensing accuracy), positioning-related actions, and/or common actions (e.g., directly related to both sensing and positioning).

For example, positioning-related actions performed by the WTRU 302 may include at least one of the following: sending UL-assistance information via LPP (e.g., indicating positioning is not reliable, reporting error of particular type or source); logging positioning measurements (e.g., defining log start time, stop time, what is logged, timeout, behavior after logging, or the like); stopping RAT-based positioning; applying non RAT-based positioning; enabling a new set of positioning measurements; combinations of the same; or the like.

For example, sensing-related actions (e.g., to improve positioning performance) performed by the WTRU 302 may include at least one of the following: performing one or more sensing measurements; identifying alternative paths/RSs to measure, e.g., detect that LOS paths are blocked; estimating expected duration of error by sensing blockage object type; using additional information from the sensing framework to better estimate WTRU position; using sensing to improve LOS detection and clutter removal; indicate coarse WTRU location based on sensing measurements when LOS is missing (e.g., identifying upper and/or lower bound base on sensing measurements of a second path); combinations of the same; or the like.

For example, common actions performed by the WTRU 302 may include at least one of the following: validating measurements (e.g., sensing and/or positioning measurements) and determining an associated validity window; triggering a set of reports conditioned by measurement validation; determining a reporting mode as a function of the triggering event (e.g., for sensing and/or positioning reporting); combinations of the same; or the like. Further, for example, the WTRU 302 may report only the sensing report to the network 304 based on determining that the positioning is valid. The WTRU 302 may report the positioning measurements in addition to the sensing report to the network 304 based on determining that the positioning is not valid.

In certain embodiments, the WTRU 302 may receive 316 a DL message from the network 304 including at least one of the following: a reconfiguration for positioning (e.g., a change in positioning method); a reconfiguration for sensing; a reconfiguration (e.g., via RRC) including an add or remove list request (e.g., measID list, measObject list, reportconfig list, or the like); updated assistance information (e.g., for positioning and/or sensing); combinations of the same; or the like.

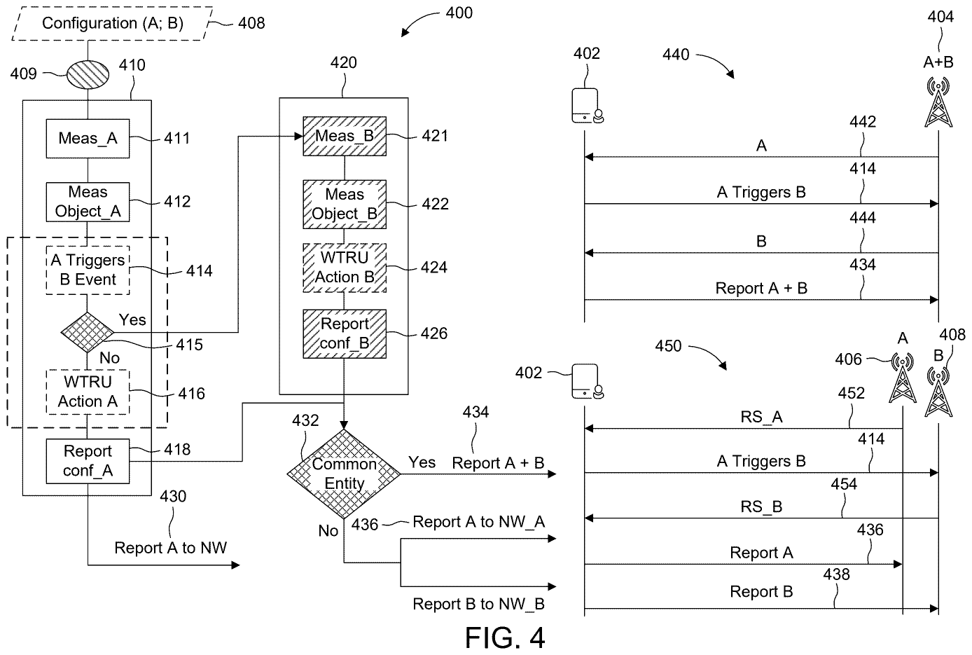

FIG. 4 is a chart 400 illustrating an example first WTRU procedure (e.g., procedure A 410) that triggers a second WTRU procedure (e.g., procedure B 420), according to one or more embodiments. As shown in FIG. 4, in certain representative embodiments, the WTRU 402 in configured (e.g., by TRP 404, 406, and/or 408) with two procedures: procedure A 410 (e.g., positioning) and procedure B 420 (e.g., sensing). For example, before the procedure A 410, initiation and/or priority between configured procedures may be provided at 409 (e.g., the WTRU 402 executes Procedure A 410 first, then triggers Procedure B 420 once the one or more of the defined conditions and/or events are met). Also, for example, the procedure A 410 may include applying a measurement configuration A 411, measuring 412 a reference signal to obtain a measurement (e.g., positioning measurement) of a target, and monitoring for an event trigger 414. Further, for example, the procedure A 410 may trigger procedure B 420 based on determining 414 that the event trigger is satisfied (e.g., 415=“Yes”) or may perform 416 action A based on determining 414 that the event trigger is not satisfied (e.g., 415=“No”). Moreover, for example, procedure A 410 may proceed to generating 418 a report A (e.g., positioning report) and send 430 report A to the network. Also, for example, procedure B 420 may include applying a measurement configuration B 421, measuring 422 a reference signal to obtain a measurement (e.g., sensing measurement) of a target, and performing 424 action B 424. Still further, for example, procedure B 420 may proceed to generating 426 a report B and proceed to decision block 432.

As shown in FIG. 4, in certain representative embodiments, the WTRU 402 may be under unified control by a single TRP (e.g., controlling both procedure A 410 and procedure B 420) or under separate control by multiple TRPs (e.g., a TRP 406 for controlling procedure A 410 and a TRP 408 for controlling procedure B 420). For example, at decision block 432, the WTRU 402 under unified control may send 434 report A and report B to node 404 controlling both procedures (e.g., 432=“Yes”). Further, for example, at decision block 432, the WTRU 402 under separate control may send 436 report A to TRP 406 and send 438 report B to TRP 408 (e.g., 432=“No”).

Chart 440 illustrates an example WTRU 402 performing procedure A 410 and procedure B 420 under unified control of TRP 404. For example, TRP 404 sends 442 the configuration A to WTRU 402 for measurement in procedure A 410. Further, for example, based on receiving an indication of the triggering 414 of procedure B 420, the TRP 404 sends 444 configuration B to WTRU 402 and additionally receives 434 both report A and report B 434 from WTRU 402.

Chart 450 illustrates an example WTRU 402 performing procedure A 410 and procedure B 420 under separate control of TRP 406 and TRP 408. For example, TRP 406 sends 452 reference signal A for measurement by the WTRU 402 during procedure A 410. Further, for example, based on receiving an indication of the triggering 414 of procedure B 420, the TRP 406 sends 454 reference signal B to WTRU 402. Moreover, for example, the WTRU 402 sends 436 report A to TRP 406 and sends 438 report B to TRP 408.

In certain representative embodiments, the WTRU may perform 424 action B based on the event trigger 414 (e.g., associated with procedure A) to improve the measurement accuracy of procedure A 410. For example, WTRU-based measurements and event triggers may associated to a first RS type A (e.g., or a first quantity thereof) and may trigger similar WTRU-based behavior based on a second RS type B (e.g., or a second quantity thereof).

In accordance with certain embodiments of the present disclosure, configuration of the WTRU for sensing-assisted positioning is described as follows.

In certain representative embodiments, the WTRU receives a configuration from the network that includes an indication to start a positioning task and/or operation. The WTRU may receive the configuration via RRC signaling, MAC-CE, DCI, or the like). The configuration may include at least one of the following: positioning configuration; sensing configuration; reference signal configuration; reporting configuration; positioning assistance information; WTRU capabilities; initiation procedure; combinations of the same; or the like.

In certain representative embodiments, the positioning configuration includes positioning related information (e.g., positioning method, measurements, error sources, corresponding triggers) that may include at least one of the following parameters: an indication (e.g., a flag) to activate the positioning task; a time window for the positioning task procedure, e.g., starting time, minimum and/or maximum duration, number of measurement occasions for update and termination; PRS configuration; positioning measurement configuration; triggers for initiating or terminating the positioning task; sensing events that are triggers for positioning; sensing events that affect positioning measurement; conditions for activating sensing task with assisted positioning; signaling protocols for exchanging positioning information and measurements and/or report modes; standalone sensing configuration or common configuration (e.g., for both positioning and sensing); combinations of the same; or the like.

For example, a PRS configuration may include at least one of the following: number of symbols; transmission power; number of PRS resources included in PRS resource set; muting pattern for PRS (e.g., the muting pattern may be expressed via a bitmap); periodicity; type of PRS (e.g., periodic, semi-persistent, or aperiodic); slot offset for periodic transmission for PRS; vertical shift of PRS pattern in the frequency domain; time gap during repetition; repetition factor; resource element (RE) offset; comb pattern; comb size; spatial relation; quasi co-location (QCL) information (e.g., QCL target, QCL source) for PRS; number of PRUs; number of TRPs; absolute radio-frequency channel number (ARFCN); subcarrier spacing; expected RSTD; uncertainty in expected RSTD; start Physical Resource Block (PRB); bandwidth; BWP ID; number of frequency layers; start/end time for PRS transmission; on/off indicator for PRS, TRP ID, PRS ID, cell ID, global cell ID, PRU ID, and applicable time window; combinations of the same; or the like. Further, for example, the WTRU may apply a PRS configuration under a condition that the current time is within the applicable time window.

For example, positioning measurement configuration information may include at least one of the following: RSs; positioning measurement periodicity, e.g., periodic, aperiodic (e.g., DCI-triggered), semi-persistent (e.g., MAC-CE activated); positioning measurement triggers; sets of positioning measurements, e.g., RSRP, reference signal received power per path (RSRPP), ToA, AoA, doppler, micro-Doppler (MD), CIR, power delay profile (PDP), or the like; combinations of the same; or the like.

For example, triggers for initiating or terminating the sensing task include at least one of the following: location-based triggers, QoS-based triggers, mobility-based triggers, time-based triggers, event-based triggers, determined error type, determined error source, combinations of the same, or the like.

For example, the location-based triggers may correspond to when the WTRU enters and/or leaves a certain geographical area, or when it detects proximity to a particular target or location. In one example, the WTRU may be triggered to initiate or terminate a target sensing task if a difference between the measured WTRU location (e.g., using RAT-dependent and/or non-RAT based methods) and the configured target location are below a certain threshold.

Also, for example, the QoS-based triggers may be based on positioning estimation requirements or positioning-based QoS (e.g., positioning accuracy). The WTRU may initiate a sensing procedure to improve the positioning accuracy by improving sensing.

Further, for example, the mobility-based triggers include accounting for the WTRU being stationary or mobile. In one example, the WTRU may be triggered to activate or deactivate a sensing procedure if the measured WTRU velocity is above a threshold value and/or within a range of threshold values. In another example, the WTRU may be triggered to activate or deactivate a target sensing task if the difference between the measured WTRU velocity and the configured target velocity is below a threshold value.

In addition, for example, the time-based triggers include the WTRU initiating or terminating a sensing task at predefined intervals for periodic monitoring.

Moreover, for example, the event-based triggers include the WTRU initiating or terminating a sensing procedure when certain signal parameters (e.g., peak to side lobe, SINR, RSRP, interference level, or the like) are above or below one or more preconfigured and/or configured thresholds.

Furthermore, for example, the determined error type may include a systematic or random error type. In one example, the WTRU may initiate or terminate sensing if a systematic error is detected. In another example, the WTRU may request a configuration modification (e.g., using on-demand PRS request) if the determined error type is random.

For example, while performing positioning measurements, the WTRU may activate a set of sensing measurements that are not related to the determined error source (e.g., the determined error source is angle-based and the WTRU activates time-based or phase-based sensing measurements).

For example, the triggers may impact sensing measurements or sensing configuration. In one example, if an error source A is determined in the positioning measurements, sensing measurement set B is activated. Further, for example, triggers may impact reporting for sensing (e.g., including sensing measurements with positioning measurements, reporting modes, granularity, or the like).

For example, conditions for activating sensing task with assisted positioning may include an indication (e.g., a flag) to activate the positioning with sensing-related conditions or the reliability of sensing measurements. In one example, the WTRU receives a request from the network (e.g., via MAC-CE) to enable one or more of the sensing-related conditions and triggers for a certain sensing task.

In certain representative embodiments, the sensing configuration includes a sensing measurement task (e.g., detection, tracking, identification, or the like) and corresponding triggers that include at least one of the following parameters: an indication (e.g., a flag) to activate the sensing task; a time window for the sensing task procedure, e.g., starting time, minimum and/or maximum duration, number of measurement occasions for update and termination; measurement configuration information; a sensing window that may be allocated and dependent upon sensing requirements, WTRU capabilities, and/or positioning requirements of the WTRU; signaling protocols for exchanging sensing information and measurements and/or report modes; combinations of the same; or the like.

For example, measurement configuration information may include at least one of the following: RSs; measurement periodicity, e.g., periodic, aperiodic (e.g., DCI-triggered), semi-persistent (e.g., MAC-CE activated); measurement triggers; sets of measurements, e.g., RSRP, reference signal received power per path (RSRPP), ToA, AoA, doppler, MD, CIR, power delay profile (PDP), or the like; sets of key performance indicators (KPIs), e.g., resolution, accuracy, or the like; combinations of the same; or the like.

In certain representative embodiments, the reference signal configuration includes information about the reference signal resources described as follows.

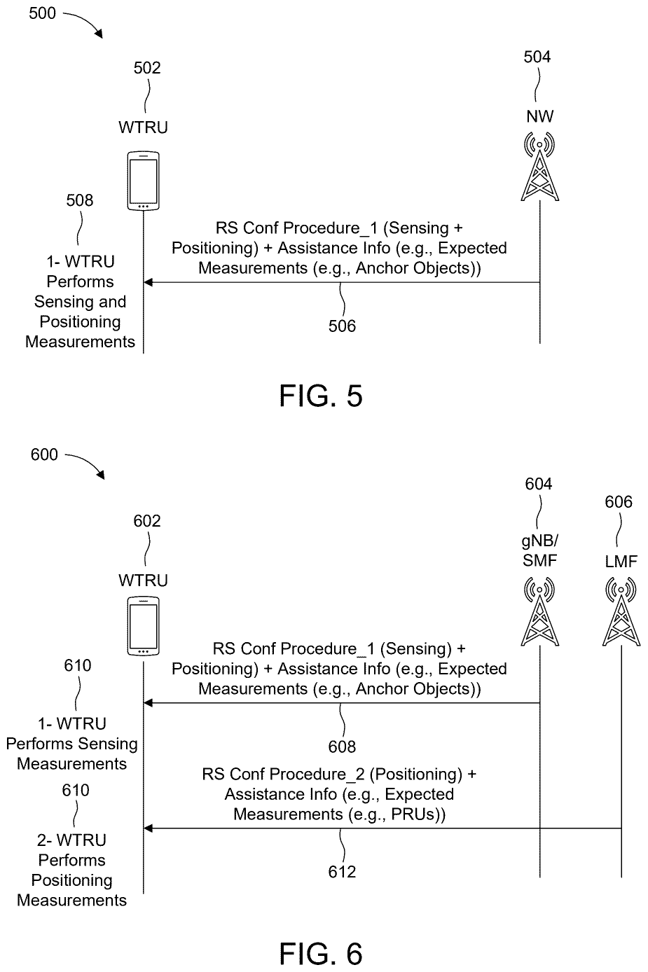

FIG. 5 is a chart 500 illustrating an example of DL signaling 506 for configuration of a WTRU 502 for sensing and positioning under unified network control, according to one or more embodiments. As shown in FIG. 5, for example, an RS is used to perform both sensing and positioning (e.g., DL PRS) sent 506 to the WTRU 502 by node 504 of the wireless network. In this example, the unification may simplify the system design and reduce the overhead associated with managing multiple signals, leading to more efficient use of resources. Further, for example, the NW node 504 may include a gNB, LMF, or the like, that coordinates both sensing and positioning. Additionally, for example, the WTRU 502 may receive 506 a combined configuration to perform 508 sensing and positioning measurements. Moreover, for example, the combined configuration may have impacts on RS configuration, measurement configuration information including common measurements used for sensing and positioning, event triggers, triggered actions, assistance information, thresholds, or the like.

FIG. 6 is a chart 600 illustrating an example of DL signaling for configuration of a WTRU 602 for sensing and positioning under separate network control, according to one or more embodiments. As shown in FIG. 6, in some embodiments, a RS is configured for each task, with one RS dedicated to sensing (e.g., CSI-RS, sensing RS, or the like) and another RS dedicated to positioning (e.g., DL-PRS, or the like). In such embodiments, the separation of RS by task enables the design of each signal according to its specific requirements, potentially enhancing the accuracy and performance of both sensing and positioning functions. For example, the network node 604 (e.g., gNB, SMF, or the like) may send 608 a sensing configuration (e.g., including the RS dedicated to sensing and/or assistance info) to the WTRU 602. Further, for example, the WTRU 602 may perform 610 sensing measurements based on the received sensing configuration. Additionally, for example, the network node 606 (e.g., LMF, or the like) may separately send 612 a distinct positioning configuration (e.g., including the RS dedicated to positioning and/or assistance info) to the WTRU 602. Moreover, for example, the WTRU 602 may perform 614 positioning measurements based on the received positioning configuration. In some examples, communication between the sensing node 604 and the positioning node 606 may be required. Furthermore, for example, the separate configurations may impact RS configuration, measurement configuration, event triggers, triggered actions, or the like.

In certain representative embodiments, a measurement window associated with reference signal configuration for sensing and/or positioning is defined based on at least one of the following: length (e.g., absolute, relative to the target size, or the like); start or end time of the window (e.g., in terms of symbol index, slot index, frame index, absolute time, relative time with respect to a reference point, or the like); duration of the window (e.g., in terms of number of symbols, slots, frames, subframes, seconds, or the like); triggers for activating and/or deactivating the measurement window; triggers for increasing and/or decreasing the length of the measurement window; combinations of the same; or the like.

In certain representative embodiments, the reporting configuration may include at least one of the following: reporting periodicity information; reporting resources, e.g., uplink resources such as transmission power, resource blocks, and scheduling information; conditions for reporting positioning measurements in addition to sensing information (e.g., event-based, time-based, threshold-based); conditions for content included in the sensing-assisted positioning report and sensing-assisted positioning report format; timing reporting granularity factor; retroactive association mechanics between one or more sensing reports (e.g., and/or sensing objects) and one or more positioning reports (e.g., and/or positioning objects) (e.g., start, stop, association method, associated reports and/or objects, or the like); signaling protocols for exchanging sensing and positioning information, and measurements (e.g., including the destination for each reporting mode); reporting ID; combinations of the same; or the like.

For example, the reporting periodicity may include at least one of the following: a type (e.g., periodic, aperiodic, semi-persistent, or the like); period time between successive reports (e.g., for periodic and semipersistent reporting types); report types associated to each periodicity type (e.g., report x is periodic, while report y is semipersistent); combinations of the same; or the like.

For example, conditions for content included in the sensing-assisted positioning report and sensing-assisted positioning report format may include at least one of the following: whether the data is raw or processed; whether the data is statistical or instantaneous; detection of particular events; particular actions performed by the WTRU, time granularity, measurement window, combinations of the same; or the like. Further, for example, the report contents and format may include at least one of the following: primary measurement related information (e.g. positioning measurement information); primary measurement related information (e.g. positioning measurement information) in addition to secondary related measurements (e.g., sensing measurement information); a specific source (e.g., angle, time, phase, channel, or the like) of primary and/or secondary measurements; raw and/or processed data; statistical and/or instantaneous data; detected event triggers, e.g., systematic error associated with positioning error;

WTRU actions performed; a measurement window; a recommendation or request of a certain reconfiguration; combinations of the same; or the like.

For example, the timing reporting granularity factor may be configured based on the sensing measurement, determined error type, and/or determined error source. In one example, if the determined error type is systematic, the timing reporting granularity factor is x. In another example, if the determined error type is random, the timing reporting granularity factor is y. In another further example, if the determined error source is angle-based, the timing reporting granularity factor is z. For example, the timing reporting granularity factor may be configured based on at least one of the following: RS metrics (e.g., RSRP, RSRPP, CIR, signal-to-interference-plus-noise ratio (SINR), reference signal received quality (RSRQ), or the like); required quality of sensing, a predefined power saving mechanism; combinations of the same; or the like.

For example, the reporting ID may include at least one of the following: a sensing measurement ID; a positioning measurement ID; a RS ID (e.g., RS_1 for sensing, RS_2 for positioning, RS_3 for sensing and positioning); target IDs; combinations of the same; or the like.

In certain representative embodiments, the network provides the WTRU with positioning assistance information that includes parameters to aid in performing sensing and positioning measurements. For example, the WTRU may receive the assistance information associated with a positioning task and/or operation from the network. Further, for example, the WTRU may receive the positioning assistance information semi-statically (e.g., via LPP or RRC messages) and may either be initiated upon the request by the network or sent uninitiated. The assistance information may consist of at least one of the following: sensing-related assistance information; WTRU positioning information; hierarchal measurements and dependencies; error source and/or type determination procedures; mechanics for logging erroneous sensing measurements (e.g., conditions, duration, actions upon resuming, activation, termination, timeout, actions upon termination, or the like); reporting assistance information; validity time for sensing assistance information; positioning methods based on possible error sources; error handling and measurement strategies; combinations of the same; or the like.

For example, sensing-related assistance information may include at least one of the following: a target identifier; target positioning information; target type (e.g., unmanned aerial vehicle (UAV), human, drone, autonomous ground vehicle (AGV), or the like); sensing target mobility information; combinations of the same; or the like.

For example, the sensing target identifier may be associated to the target type (e.g., human, vehicle, rocks, or the like) and/or the location. In one example, the identifiers for targets of a shared type and/or location are selected from different pools. In another example, the identifiers for targets of a shared type are selected from the same pool.

For example, sensing target positioning information may include at least one of the following: target positioning reference information (e.g., SRUs); target coarse location (e.g., location provided as an area defined between certain coordinates, cell IDs, sector IDs, or the like); statistical distribution for one or more measurements (e.g., AoA follows uniform distribution defined in degrees or radians); range of values for one or more measurements (e.g., velocity may be between 3.2-6.4 km/hour for a walking human); combinations of the same; or the like. Further, for example, the target positioning reference information may be absolute (e.g., target coordinates (x; y; z;)) or relative (e.g., with respect to the coordinates and/or orientation of the TRP and/or WTRU). In one example, the WTRU receives the target positioning and/or orientation information relative to the WTRU location.

For example, the sensing target type may be represented by at least one of the following: RCS profile, MD profile, measurement ranges, measurement distributions, measurement rate of change, combinations of the same, or the like.

For example, sensing target mobility information may be absolute (e.g., target velocity, doppler frequency, or the like), relative (e.g., with respect to the WTRU and/or TRP velocity), and/or include an uncertainty range (e.g., velocity and/or doppler frequency uncertainty).

For example, WTRU positioning information may include at least one of the following: WTRU positioning reference information (e.g., PRUs); WTRU coarse location (e.g., location provided as an area defined between certain coordinates, cell IDs, sector IDs, or the like); statistical distribution for one or more measurements (e.g., AoA follows uniform distribution between 35-68 degrees and may also be defined in radians); range of values for one or more measurements (e.g., RSTD may be a value between 1-2 ms); combinations of the same; or the like. Further, for example, the WTRU positioning reference information may be absolute (e.g., target coordinates (x; y; z;)) or relative (e.g., with respect to the coordinates and/or orientation of the TRP and/or WTRU). In one example, the WTRU receives the WTRU and/or TRP positioning and/or orientation information in order to assist the WTRU to calculate the target location relative to the WTRU and/or TRP locations.

For example, the hierarchal measurements and dependencies may include structured rules related to hierarchal measurement events that trigger other events and reports. In some examples, the rules are between sets of measurements under the same procedure (e.g., sensing measurements). For example, AoA and RCS are both sensing measurements and the rules indicate that the secondary measurement RCS depends on the primary measurement AoA. Further, for example, an error in the primary measurement AoA always propagates to the secondary measurement RCS but an error in the secondary measurement RCS does not always indicate a problem an error in the primary measurement AoA. In other examples, the rules are between two different procedures (e.g., between sensing measurements and positioning measurements). For example, the secondary measurement ToA for sensing (e.g., non-line of sight (NLOS)) depends on the primary measurement ToA for positioning (e.g., line of sight (LOS)). In some examples, the rules are structured based on measurement type (e.g., angle-based, time-based, or the like). For example, the secondary measurement AoA for sensing depends on the primary measurement AoA for positioning. In other example, the measurements are treated as the baseline and the rules do not indicate any dependencies between the measurements.

For example, error source and/or type determination procedures may be based on at least one of: one or more measurements to be used, corresponding measurement distributions, number of samples per decision, granularity level, thresholds to be compared, sensing time window, positioning time window, additional processing of measurements, rules for error type classification and determination, rules for error source categories, combinations of the same, or the like.

In some examples, the reporting assistance information may include information for association to the positioning measurement ID. For example, the positioning target ID may be the same or a part of the target ID and/or associated to one or more positioning measurement IDs. Also, for example, multiple positioning target IDs may be associated to one or more positioning measurement IDs. In some examples, the reporting assistance information may include information for association to the sensing measurement ID and positioning measurement ID. For example, the positioning measurement ID may be the same or a part of the sensing measurement ID and/or associated to one or more positioning measurement IDs. Moreover, for example, multiple sensing measurement IDs may be associated to one or more positioning measurement IDs.

For example, positioning methods associated with possible error sources include time-based positioning (e.g., trilateration-based) and angle-based positioning (e.g., triangulation-based). Further, for example, time-based positioning requires precise WTRU-gNB and/or gNB-gNB synchronization and may be limited by multipath propagation conditions that make measurements unreliable. Moreover, for example, time-based positioning includes at least one of the following procedures: DL-TDoA, UL-TDoA, multi-RTT, combinations of the same, or the like.

For example, DL-TDoA procedures include the WTRU measuring ToA for each PRS of one gNB as a reference and the RSTD to ToA from the remaining gNBs. Additionally, for example, the WTRU sends RSTD to LMF to compute absolute measurements using known geographical coordinates of gNBs. Further, for example, DL-TDoA measurements include ToAs and RSTDs, while possible error sources are RSTD measurements, TRP location, and/or inter-TRP synchronization.

For example, UL-TDoA procedures include the WTRU using SRS to measure round-trip time of arrival (RToA) and send it to the LMF. Further, for example, the measurements involved in this procedure are RTOA measurements and possible error sources include RTOA measurements, TRP location, and/or inter-TRP synchronization.

For example, multi-RTT procedures include the WTRU performing receive-transmit (Rx-Tx) time difference measurement for the signal of each cell, e.g., using PRS and SRS. Further, for example, LMF initiates the procedure whereby multiple gNBs and a WTRU perform the gNB Rx-Tx and WTRU Rx-Tx measurements, respectively. Also, for example, multi-RTT may have a higher accuracy than TDoA-based methods and more relaxed requirements on time-synchronization. Additionally, for example, the measurements involved in this procedure include gNB Rx-Tx time difference and WTRU Rx-Tx time difference and possible error sources include WTRU Rx-Tx time difference measurements, gNB Rx-Tx time difference measurements, and/or TRP location.

For example, angle-based positioning includes DL-AoD and UL-AoA procedures.

Further, for example angle-based positioning procedures may be limited in angular resolution of reportable absolute values for power measurements (e.g., [−156, −31] dBm with 1 dBm resolution).

For example, DL-AoD procedures include the WTRU measuring the beam RSRP of gNB and reporting it to the LMF via LPP. Further, for example, the measurements associated with the procedure include RSRPP and RSRP and possible error source include WTRU-assisted TRP location, RSRPP, and/or RSRP.

For example, UL-AoA procedures include the gNB using SRS to measure AoA (e.g., azimuth and elevation angles) and reporting them to the LMF via the NRPPa. Further, for example, the measurements associated with the procedure include gNB AoA and possible error sources include AoA measurements, TRP location, and/or access reservation protocol (ARP) location.

For example, the validity time may refer to the total time duration when the positioning assistance information that is provided by the network can be associated to the target. Further, for example, the validity time may be configured in terms of number of symbols, slots, frames, subframes, seconds, or the like.

In some examples, the WTRU transmits the UL positioning assistance information to the network uninitiated (e.g., without an indication from the network). For example, the WTRU may transmit the UL sensing assistance information uninitiated based on determining at least one of the following: the positioning methods supported may assist the network in allocating the positioning configuration; the determined error sources in the positioning measurements may assist the network in allocating the right sensing task and the relevant sensing configuration; indicating the measurements in error may assist the network in allocating the right resources for sensing for similar and/or dependent measurements; combinations of the same; or the like.

In certain representative embodiments, the WTRU receives and decodes a first network request (e.g., received through RRC signaling) to provide capability information. For example, the WTRU receives and decodes the request following the random-access procedure. Further, for example, the WTRU prepares a capability information message including at least one of the following: sensing processing capabilities (e.g., sensing modes, inverse frequency transform capabilities, maximum number of samples, or the like); sensing-related capabilities; positioning-related capabilities and/or processing capabilities (e.g., supported positioning methods, measurements, determination of error sources and/or inaccuracies, reporting modes, or the like). Moreover, for example, sensing-related capabilities may include at least one of the following: sensing modes; sensing bandwidth; sensing frequency ranges; sensing spatial resolution; sensing time resolution; sensing angular resolution; sensing doppler resolution; phase resolution; sensing measurements; support of half-duplex or full duplex for subject to sensing mode; reflectivity sensitivity (e.g., the minimum power, signal-to-noise ratio (SNR), absolute amplitude, or the like for the reflections to be detectable by the WTRU), reporting modes; combinations of the same; or the like. In some examples, the WTRU sends the WTRU capability information message through RRC signaling, e.g., over the physical uplink shared channel (PUSCH).

In certain representative embodiments, the WTRU receives triggers for initiating the sensing-assisted positioning procedure as a part of the first configuration (e.g., positioning configuration) received from the network. For example, the WTRU may monitor triggers (e.g., time-based, event-based, location-based, mobility-based, QoS-based, or the like) and upon the detection of a trigger, the WTRU may activate, deactivate, receive, request, and/or suggest a positioning and/or sensing configuration to initiate positioning-assisted sensing. Further, for example, the positioning-assisted sensing procedure may be initiated explicitly via UL signaling (e.g., RRC signaling, MAC-CE, dedicated DCI, uplink control information (UCI), reference signal transmissions, LPP messages, or the like) or initiated implicitly through selection of certain UL resources (e.g., resources related to physical random-access channel (PRACH), physical uplink control channel (PUCCH), PUSCH, spatial relation info, or the like).

In some examples, the WTRU may receive a first configuration from the network to initiate sensing-assisted positioning and additionally report sensing and positioning information based on conditions within the initial configuration being satisfied. For example, the WTRU may request for another positioning and/or sensing configuration from the network based on determining an error (e.g., type and/or source) and/or that the sensing measurement is not reliable. Further, for example, the WTRU may receive another positioning and/or sensing configuration from the network to improve sensing task reliability or QoS. Also, for example, the configuration may include an additional set of measurements and/or assistance information not included in the first configuration as well as more granular information for WTRU assistance. Furthermore, for example, the WTRU may receive a request from the network to activate the positioning-assisted sensing procedure.

In accordance with certain embodiments of the present disclosure, systems and methods for performing measurements with the WTRU are described as follows.

In certain representative embodiments, the WTRU performs sensing measurements based on a received a sensing configuration including a set of RS resources (e.g., a SSB, CSI-RS, PRS, a dedicated RS for sensing, or the like). For example, the WTRU may perform the configured measurement in the allocated measurement time window indicated to the WTRU. Further, for example, the time window configuration may include at least one of the following: a start or end time of the window (e.g., in terms of symbol index, slot index, frame index, absolute time, relative time with respect to a reference point, or the like); a duration of the window (e.g., in terms of number of symbols, slots, frames, subframes, seconds, or the like); periodicity of the window (e.g., in terms of number of symbols, slots, frames, subframes, seconds, or the like); combinations of the same; or the like.

For example, the WTRU may be configured by the network to measure at least one of the following using the associated time from the resources: ToA, TDoA, AoA, absolute or relative RSRPP, reference signal carrier power (RSCP), doppler spectrum, MD, RCS, combinations of the same, or the like.

For example, the WTRU may activate and/or apply a new configuration for a second type (e.g., dependent) measurement (e.g., positioning-assisted sensing). Further, for example, the new configuration may be associated to the characteristics of an error (e.g., error type and/or error source). The new configuration may cause the WTRU to apply at least one of the following: a different sensing measurement granularity; different measurement quantity and/or methods; different set of sensing measurements (e.g., only common measurements with positioning measurements); combinations of the same; or the like.

In certain representative embodiments, the WTRU performs positioning measurements based on a received positioning configuration including a set of RS resources for positioning (e.g., DL-PRS or the like). For example, the WTRU may perform the configured measurement in the allocated measurement time window indicated to the WTRU. Further, for example, the time window configuration may include at least one of the following: a start or end time of the window (e.g., in terms of symbol index, slot index, frame index, absolute time, relative time with respect to a reference point, or the like); a duration of the window (e.g., in terms of number of symbols, slots, frames, subframes, seconds, or the like); periodicity of the window (e.g., in terms of number of symbols, slots, frames, subframes, seconds, or the like); combinations of the same; or the like.

In some examples, the WTRU is configured by the network to measure at least one of the following using the associated time from the resources: ToA, RSTD, AoA, absolute or relative RSRPP, combinations of the same, or the like. In some examples, the WTRU is configured by the network to perform the set of positioning measurements based on one or more RAT-based positioning methods. For example, the WTRU may be configured by the network to apply a defined set of measurements, error sources, number of samples, granularity level, measurement window, or the like per-positioning method (e.g., per-positioning method described above). Further, for example, the WTRU may be configured by the network to estimate the reliability of one or more of the positioning measurements.

In certain representative embodiments, the WTRU may be configured with a common RS to perform both sensing and positioning measurements. Table 1 is a measurement table for different measurement procedures categorized based on measurement type.

TABLE 1

| | Positioning | | Common |
|---|---|---|---|
| Measurement category | measurements | Sensing measurements | measurements |
| Timing-based | ToA (e.g., first path), | ToA (e.g., NLOS), | |
| | RSTD, WTRU/gNB | RSTD (e.g., 2nd path), | |
| | receive-transmit (Rx-Tx) | WTRU/gNB/target Rx- | |
| | time difference | Tx time difference | |
| Angle-based | azimuth (Az)-AoA, | Az-AoA, Ze-AoA, Az- | Az-AoA, Ze-AoA, |
| | zenith (Ze)-AoA, Az- | AoD, Ze-AoD, | Az-AoD, Ze-AoD |
| | AoD, Ze-AoD | incident angle | |
| Power-based | RSRP, RSRPP | RSRP, RSRPP, RCS, | RSRP, RSRPP |
| | | peak to sidelobe | |
| Channel-based | CIR, PDP, delay profile | CIR, PDP, DP | CIR, PDP, DP |
| | (DP) | | |
| Target-based | | RCS, MD | |
| Phase-based | DL RSCP; DL RSCP-D | Doppler estimation | |

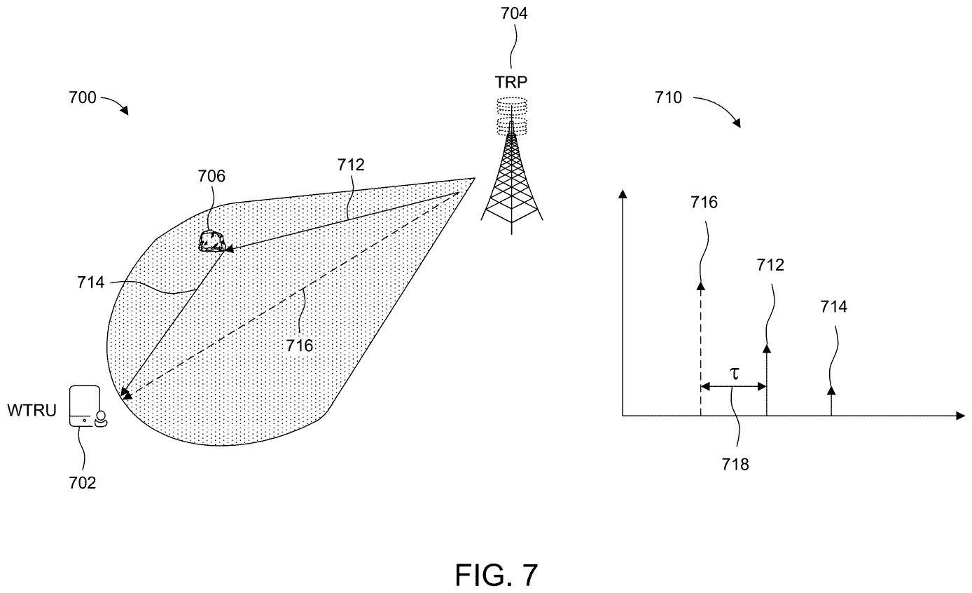

FIG. 7 is a diagram 700 illustrating an example of CIR behavior for sensing and positioning using common RSs, according to one or more embodiments. As shown in FIG. 7, in some examples, the WTRU 702 is configured with time and frequency resources to perform configured measurements related to sensing and/or positioning of a target object 706 on a common RS in connection with a TRP 704. For example, the WTRU 702 may receive the single RS to perform sensing and positioning and may obtain configured measurements through channel impulse responses for sensing and positioning. Further, for example, the WTRU 702 may perform positioning measurements on a LOS path (e.g., first path 716) and sensing measurements along a NLOS path (e.g., second path consisting of 712 and 714) may be measured with respect to the LOS path of the channel impulse response. As shown in graph 710, the WTRU 702 may determine a difference 718 between the channel impulse response of the first path 716 and the channel impulse response of the second path 712.

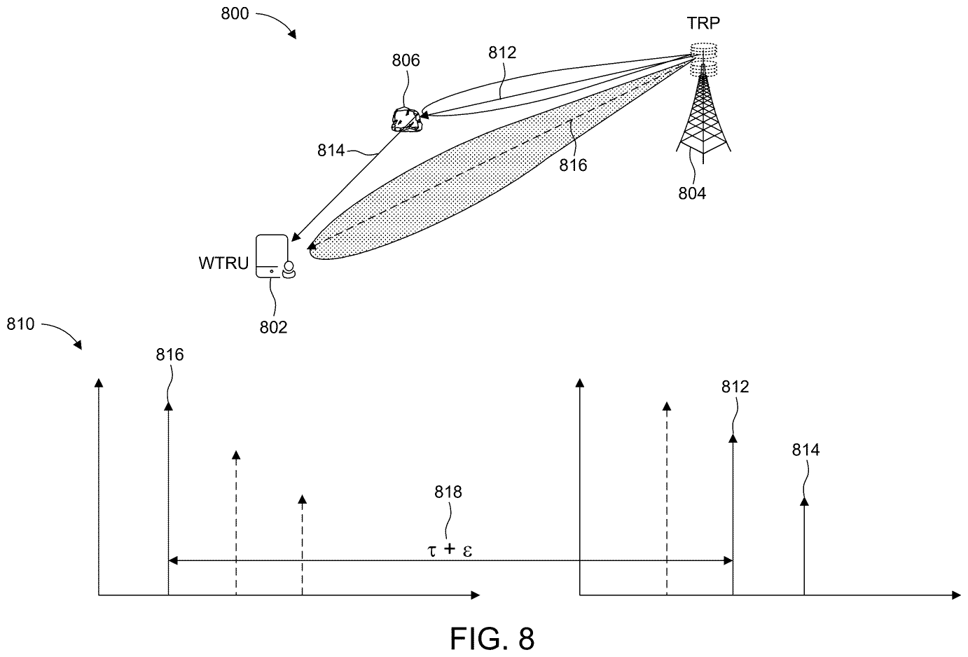

FIG. 8 is a diagram 800 illustrating an example of CIR behavior for sensing and positioning using separate RSs, according to one or more embodiments. As shown in FIG. 8, in some examples, the WTRU 802 is configured with an RS for sensing indicating time and frequency resources for the WTRU 802 to perform sensing measurements of a target object 806 in connection with TRP 804. For example, the WTRU 802 may be configured with another RS for positioning indicating time and frequency resources to perform positioning measurements. Further, for example, the WTRU 802 may perform positioning measurements on a LOS path (e.g., first path 816) and sensing measurements along a NLOS path (e.g., second path consisting of 812 and 814) may be measured with respect to the LOS path of the channel impulse response. As shown in graph 810, the WTRU 802 may determine an adjusted difference 818 between the channel impulse response of the first path 816 and the channel impulse response of the second path 812.

For example, the WTRU 802 may receive multiple RSs from one or multiple configured antenna ports for sensing (e.g., from different TRPs and/or a single TRP 804). Further, for example, the WTRU 802 may perform multiple configured measurements of the different channel responses obtained from the available TRPs and antenna ports for sensing and/or positioning. Additionally, for example, the WTRU 802 may perform relative measurements with respect to a first path 816 of the positioning channel impulse which may be directed towards the WTRU.

For example, the WTRU 802 may perform at least one of the following actions to achieve the aforementioned sensing and positioning measurements: obtaining the channel frequency responses at the configured RS resources (e.g., by removing the known values of the RS complex symbols and performing interpolation of the resulting responses over the desired frequency region); obtaining the corresponding time-domain CIR responses, e.g., by performing inverse frequency transformations on the obtained frequency responses (e.g., inverse discrete Fourier transforms); keeping the CIR or PDP peaks whose power or SNRs exceed the minimum configured RSRPP or SNR threshold (e.g., or whose peak correlation value between the received signal and the transmitted sensing signal is above a threshold) and discarding all others; keeping the CIR or PDP peaks received within a configured ToA or delay window and discarding all others; comparing the CIR or PDP responses against a configured CIR or PDP response expressed as a function of time; combinations of the same; or the like. Further, for example, the WTRU may obtain the PDP responses by computing the absolute square magnitude of the CIR responses. Additionally, for example, the WTRU may select the CIR peaks such that the difference between the probability density function (PDF) of the measured CIR or PDP response and one or more configured CIR or PDP responses are below a configured threshold.

In some examples, the WTRU is configured to perform relative measurements with respect to a predefined reference or expected value. For example, the reference point for the relative time measurements may be at least one of the following: the time instance of the WTRU request for sensing configuration; the time instance when the WTRU receives the network trigger to initiate sensing (e.g., via DCI/MAC-CE); transmit and receive time stamps; combinations of the same; or the like. Further, for example, the WTRU may measure the transmit and receive time stamps in terms of symbol index, slot index, frame index, or the like. Moreover, for example, the time stamps may be absolute, e.g., referring to the exact transmit and receive time of the RS resources (e.g., Tx time: 5th slot, Rx time 6th slot, Rx−Tx time difference=Rx timestamp−Tx timestamp=1 slot). Also, for example, the time stamps may be relative, e.g., referring to the difference in transmit and receive time of the RS resources (e.g., Rx−Tx time difference=1 slot). In some examples, the WTRU is configured to perform absolute measurements instead of relative measurements.

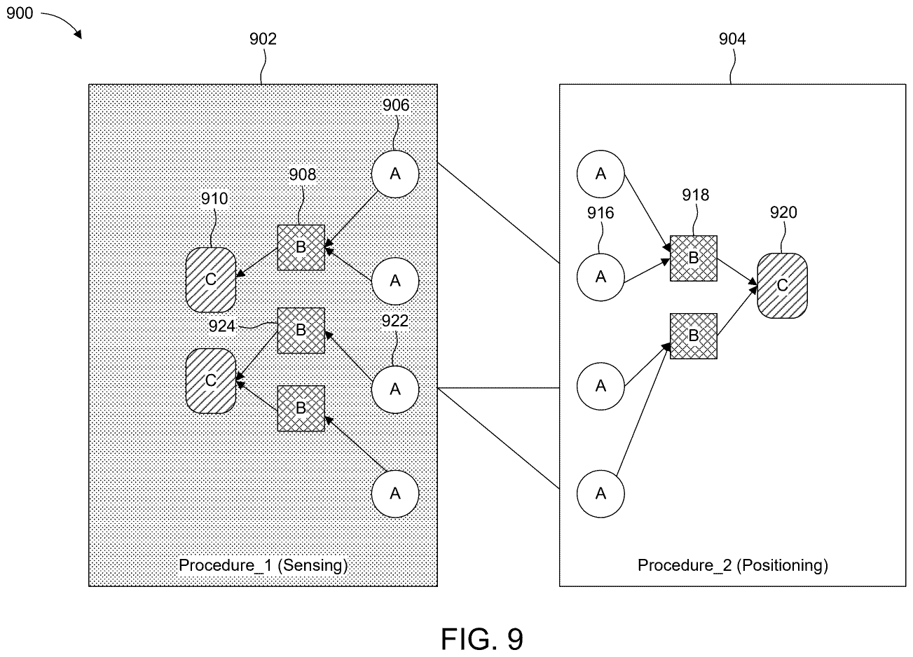

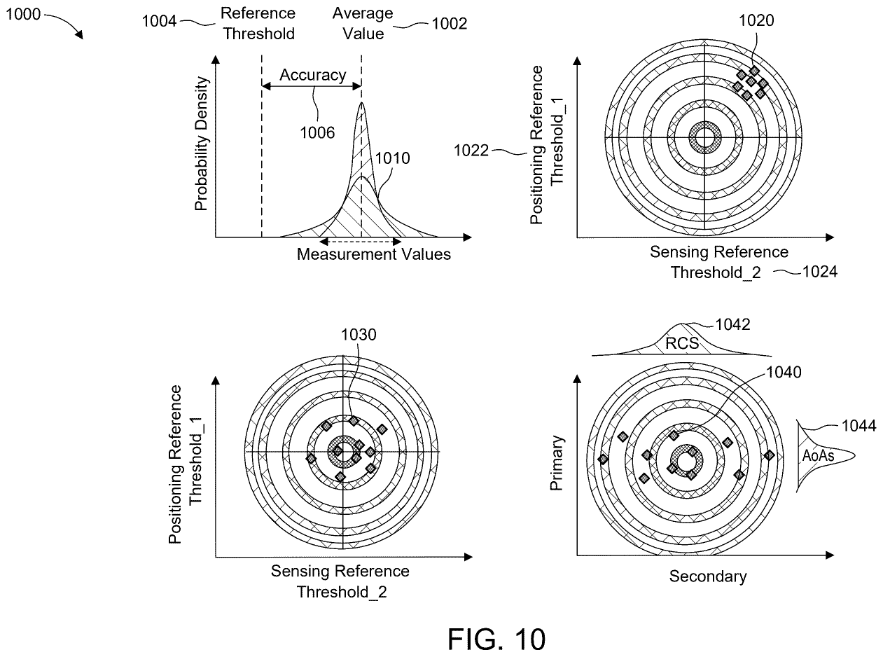

FIG. 9 is a diagram 900 of hierarchal measurement dependency within and between WTRU procedures, according to one or more embodiments. As shown in FIG. 9, in certain representative embodiments, the WTRU performs measurements based on a set of hierarchal measurements and dependencies (e.g., within or between procedures). For example, in procedure 2 904 (e.g., positioning) level A 916 corresponds to the set of measurements that are to be performed first (e.g., AoA, ToA, or the like). Further, for example, level B 918 may correspond to measurements that depend on some of the measurements performed at level A 916 (e.g., range estimation, velocity estimation, or the like). Similarly, level C 920 and higher-level measurements (e.g., RCS, MD, or the like) may depend on measurements performed at level B 918 and level A 916. Moreover, for example, a similar hierarchal structure may apply to procedure 1 902 (e.g., sensing), consisting of levels A 906, B 908, and C 910.

In some embodiments, the WTRU is configured with a set of structured rules between two different procedures (e.g., procedure 1 902 and procedure 2 904, sensing and positioning) that represents the hierarchal measurements and dependencies between the different measurements. For example, the structured rules may consider dependencies between sensing and positioning where the sensing AoA (e.g., level A 906 of procedure 1 902) measured from the target may depend on WTRU location that is a function of positioning AoA (e.g., level A 916 of procedure 2 904) measurements.

In some examples, the WTRU may start measuring the measurement set at a first level (e.g., level A 906 of procedure 1 902) with higher priority, and if the measurements are determined to be reliable, perform measurements at the second level (e.g., level B 908 of procedure 1 902). In other examples, the structured rules may be null (e.g., the rules do not indicate dependencies between measurements), and the measurements are treated as the baseline.

In one example, the WTRU is configured with trigger events as a function of hierarchal measurements and dependencies that may affect the reporting mode. For example, if a certain error pattern flow is determined to be in error (e.g., A1 906 to B1 908 to C1 910), the WTRU may perform a first set of actions (e.g., action_set1). Further, for example, in another error flow pattern (e.g., A2 922 to B2 924), the WTRU may perform another set of actions (e.g., action_set2).

In accordance with certain embodiments of the present disclosure, measurement error types and source determination procedures are described as follows.

FIG. 10 is a diagram 1000 of error determination using a single measurement or multiple measurements, according to one or more embodiments. As shown in FIG. 10, in certain representative embodiments, the WTRU is configured by the WTRU to perform error source determination for each procedure. For example, the WTRU may be configured to determine the error type and error source based on positioning measurements. Further, for example, the WTRU may be configured to determine the error type and source based on sensing measurements.

For example, the WTRU determines measurement 1010 corresponds to a systematic measurement error (e.g., positioning error) based on error determination with a single measurement. Further, for example, the WTRU determines measurements 1020 correspond to a systematic measurement error (e.g., positioning error) based on joint error determination with multiple measurements. Moreover, for example, the WTRU determines measurements 1030 correspond to a random measurement error (e.g., related to limited resources or poor channel conditions) based on joint error determination with multiple measurements. Additionally, for example, the WTRU determines that measurements 1040 has low measurement quality and/or low reliability in RCS that is not related to an error in AoA (e.g., potentially related to channel conditions or limited resources) based on hierarchal error detection techniques.

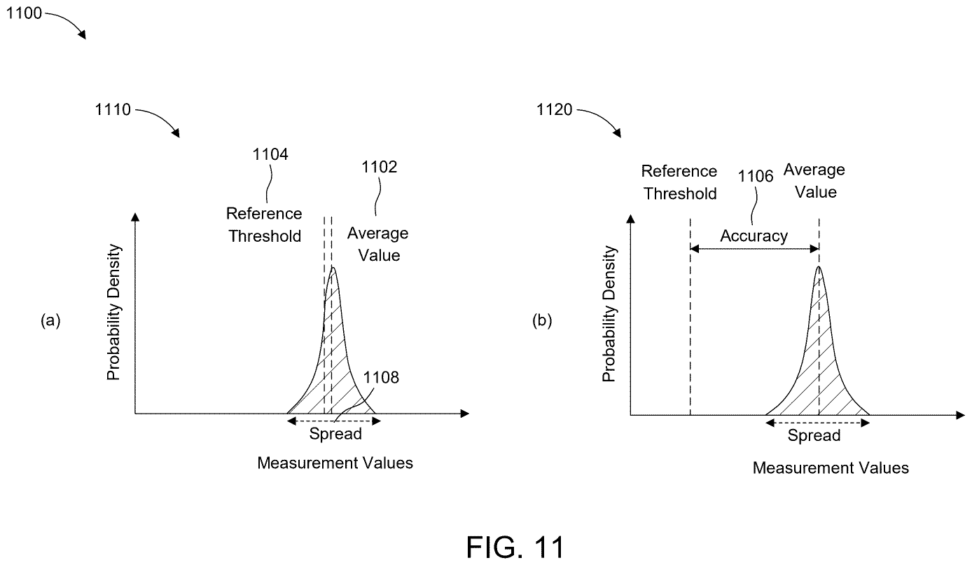

FIG. 11 is a diagram 1100 of error detection using a single measurement, according to one or more embodiments. As shown in FIG. 11, in some examples, the WTRU is configured by the network to determines errors per measurement in one or more of the sensing and/or positioning measurements, e.g., based on an average value 1102 and a reference threshold 1104. In an example scenario 1110, the WTRU determines no error based on the difference between the average value 1102 and the reference threshold 1104 (e.g., associated with accuracy 1106) being below a predefined value and/or the spread 1108 of measurements being less than a defined threshold. For example, the WTRU determines an error for an average AoA value of 34 degrees when the reference threshold is 25 degrees and the acceptable difference is 3 degrees. In example scenario 1120, the WTRU determines a systematic error type (e.g., a positioning error) based on the difference between the average value 1102 and the reference threshold 1104 (e.g., accuracy 1006) being above a predefined threshold.

In one example, the WTRU is configured by the network to determine the error source according to statistical distributions (e.g., uniform distributions, gaussian distributions) that may be included in positioning assistance information. For example, the WTRU may use Kullback-Leibler (KL) divergence to check the distribution distance from the collected samples over different measurement occasions and the configured distribution. Further, for example, if the KL divergence is above a defined threshold, then sensing is triggered. The error may still be reasonable if the KL divergence is below the defined threshold.

In some embodiments, the WTRU is configured by the network to indicate the error propagation nature from one measurement to another.

In one example, the WTRU may determine over a defined period if the error is increasing or decreasing linearly. For example, the error may be isolated and maintained by tuning the configuration. Moreover, for example, a longer validity window (e.g., for positioning measurements) may be considered after addressing the error. In another example, the WTRU may determine over a defined period if the error is changing non-linearly. For example, if the error is changing non-linearly, the configuration is changed. Additionally, for example, a short validity window (e.g., for positioning measurements) may be considered even after addressing the error.

In accordance with certain embodiments of the present disclosure, events triggering sensing and sensing-related actions are described as follows.

In certain representative embodiments, the WTRU determines to perform sensing based on periodically monitoring for events that trigger sensing, e.g., after receiving the RS configurations and the sensing time window configurations (e.g., included in the positioning assistance information). For example, the WTRU may determine to perform sensing after detecting a change in one or more positioning measurement accuracies (e.g., due to a blockage) indicated by at least one of the following conditions: receiving multiple re-transmission requests above a configured threshold; determining a change in status of a supporting TRP; determining a change in status of neighboring cells, e.g., insufficient neighboring cells to perform positioning (e.g., triangulation or trilateration methods); determining a change in status of TRP from LOS to NLOS; detecting a target blocking LOS path in one of the TRPs supporting positioning (e.g., AoA from target is within a predefined range); observing a change (e.g., decrease, increase) in the positioning RS signal measured RSRP/RSRPP values below or above a configured threshold; WTRU velocity exceeding a configured threshold; observing an increase in ToA values above a configured threshold; observing a doppler shift above or below a configured threshold; not receiving the RS in the configured time; the number of paths observed in the timing and/or power measurement is above a configured threshold; combinations of the same; or the like.

In some examples, the WTRU triggers sensing after detecting a change in an RS metric, signal parameter, and/or or other measurements as a result of at least one of the following: experiencing a change in the SNR or SINR in the communication channel above a configured threshold; receiving the RS (e.g., CSI-RS, SSB, DM-RS, or the like) with a drop in RSRP above a configured threshold; observing no LOS channel, e.g., a change in the measured channel statistics (e.g., Rician channel distribution); receiving multiple re-transmission requests above a configured threshold; combinations of the same; or the like.

In some embodiments, the WTRU triggers sensing after detecting changes in channel or environment conditions that may be result of at least one of the following: CIR, PDP characteristics changes above or below a predefined threshold; an increase or decrease in number of multipath components per CIR per RS; a number of peaks detected in CIR above a predefined threshold; combinations of the same; or the like.

In some embodiments, the WTRU triggers sensing after detecting at least one of the following integrity assessment events: the maximum positioning error allowed by the application (e.g., alert limit) exceeds a configured threshold; a probability that the positioning error is larger than the alert limit exceeds a configured threshold; an amount of time during which the position error can be higher than the alert limit before an alarm is triggered (e.g., time to alert) exceeds a configured time threshold; combinations of the same; or the like

In some embodiments, the WTRU triggers sensing based on determining the error source of positioning measurements. In one example, the WTRU is performing DL-TDOA positioning method and possible error sources may relate to RSTD measurements, TRP location, and inter-TRP synchronization. In this example, since all error source listed are related to time-based error sources, the WTRU may activate a sensing configuration with a high time resolution and and/or trigger a set of sensing measurements that are not related to time-based measurements.

In some embodiments, the WTRU triggers sensing after detecting change in the positioning assistance information that may be a result of at least one of the following: the configured positioning assistance information validity time window is not valid anymore or outdated; the WTRU receiving new or updated positioning assistance information; the WTRU receiving new RS configuration that may include positioning assistance information; the WTRU receiving new or updated error source distribution for positioning and/or sensing is configured by the network; combinations of the same; or the like.

In some embodiments, the WTRU receives an implicit indicator from the network to initiate sensing, e.g., dynamic signaling via MAC-CE, DCI, RRC or LPP message, or the like. This indication may either be triggered by the WTRU or initiated by the network to consider at least one of the following: validating the positioning measurements using sensing measurements; improve positioning accuracy by exploiting sensing measurements (e.g., used as additional source of information); detecting the positioning problem (e.g., blockage); combinations of the same; or the like.

In some embodiments, the WTRU triggers sensing as a function of the determined sensing event triggering the positioning-related action. For example, the triggers may include at least one of the following: time-based triggers, event-based triggers, mobility-based triggers, location-based triggers, QoS-based triggers, determined error type, determined error source, use case-based triggers, combinations of the same, or the like.

For example, time-based triggers may cause the WTRU to initiate or terminate sensing task measurements at predefined intervals for periodic monitoring.

For example, event-based triggers may cause the WTRU to initiate or terminate sensing task measurements when certain signal parameters such as RSRP, SINR fall below configured thresholds.

For example, mobility-based triggers may cause the WTRU to initiate or terminate sensing task measurements based on the WTRU being stationary or mobile. In one example, the WTRU is triggered to activate or deactivate a sensing task if the measured WTRU velocity is above a threshold value and/or within a range of threshold values. In another example, the WTRU is triggered to activate or deactivate a target sensing task if the difference between the measured WTRU velocity and the configured target velocity is below a threshold value.

For example, location-based triggers may cause the WTRU to initiate or terminate sensing task measurements when WTRU enters or leaves certain geographical area, or when it detects proximity to a particular target or location. In one example, the WTRU is triggered to initiate or terminate a target sensing task if the measured WTRU location (e.g., using RAT-based and/or non-RAT based methods) and the configured target location is below a certain threshold. In another example, the WTRU activates sensing when the WTRU (e.g., a drone) reaches a delivery location to safely park. The network, in another example, may also trigger the sensing process based on the WTRU's estimated location and approximate obstacle locations. The obstacle locations may be predetermined at the network or reported by other WTRUs in the vicinity.

For example, QoS-based triggers may cause the WTRU to initiate or terminate sensing task measurements based on positioning estimation requirements and/or positioning-based QoS (e.g., positioning accuracy). Further, for example, the WTRU may initiate or activate sensing to improve positioning accuracy.

For example, determined error type may cause the WTRU to initiate or terminate the sensing task measurements based on the determined error type (e.g., systematic or random error type). In one example, the WTRU initiates or terminates sensing if a systematic error is detected. In another example, the WTRU requests configuration modification (e.g., using on-demand PRS request) if the determined error type is random.

For example, determined error source may cause the WTRU to initiate or terminate the sensing task measurements based on the determined error source in positioning measurements. Further, for example, the WTRU activates a set of sensing measurements that is not related to the determined error source (e.g., the determined error source is an angle-based error source and the WTRU activates time-based or phase-based sensing measurements).

For example, the use case-based trigger may cause the WTRU to trigger sensing when the WTRU enters or leaves a certain preconfigured coarse location (e.g., drone docking onto a moving vehicle for package delivery with an extremely small margin for landing (e.g., balcony)). In this example, sensing may be beneficial to sense the environment and enable an accurate landing.

In some embodiments, the WTRU receives configurations for areas (e.g., consisting of more than one zone or cell) where the WTRU performs sensing. For example, the area where the WTRU performs sensing is referred to as the “sensing area” herein. Further, for example, the WTRU may determine to perform sensing if the WTRU determines that the WTRU location is within one of the configured areas (e.g., zone, cell). Additionally, for example, the WTRU may receive a request from the network to perform positioning and the request may contain the configurations for the sensing areas. Moreover, for example, the WTRU may receive the request from the network (e.g., LMF, gNB) via a semi-static (e.g., RRC, LPP) or dynamic message (e.g., DCI, MAC-CE).

In some examples, the WTRU determines to perform sensing based on the DL-RS configurations (e.g., PRS configurations) used for positioning. For example, the WTRU may include the DL-RS configurations details (e.g., PRS frequency layer) used for sensing when the WTRU reports sensing related measurements to the network. Further, for example, the WTRU may determine to send a request to the network for sensing configurations once the WTRU determines that the WTRU is in the configured sensing area. The WTRU may report, to the network, a cause for the request (e.g., within a configured area).

In some embodiments, the WTRU includes a measurement report in the request for DL-RS configurations for sensing. For example, the WTRU may include the WTRU location information in the report. Further, for example, the WTRU may include location uncertainty (e.g., range of the WTRU location estimate) in the report. Moreover, for example, the WTRU may include the positioning method (e.g., RAT-based positioning method such as DL-TDOA, non-RAT-based positioning method such as GNSS). Also, for example, the WTRU may receive a request from the network to perform positioning using a specific positioning method (e.g., DL-TDOA).

In one example, the WTRU performs positioning periodically and the WTRU checks periodically whether the WTRU is in the configured area for sensing.

In some examples, the WTRU is provided with validity conditions for the configuration of the area for sensing. For example, the WTRU may receive a valid duration (e.g., N minutes) for the area. Further, for example, the WTRU may determine that the sensing area is not valid if the associated valid duration expires. Moreover, for example, if the sensing area is not valid, the WTRU may determine not to check whether the WTRU's location is within the sensing area. Also, for example, the WTRU may start a timer to check if the validity duration expired. Furthermore, for example, the WTRU may determine to start a timer once the WTRU receives configurations for the sensing area.

In certain representative embodiments, WTRU actions are provided as a function of sensing conditions. In one solution, the WTRU process to monitor and/or determine whether or not positioning measurements are reliable is based on at least one of the following conditions: the WTRU determines if error sources on positioning measurements occur as a function of a performed positioning method; the WTRU performs integrity assessment of positioning measurements; the WTRU determines if a change in status of a TRP supporting and/or neighboring cells exists; the WTRU determines if a change in status of a TRP from LOS to NLOS exists; the WTRU detects if a target is blocking an LOS path in one of the TRP(s) supporting positioning; the WTRU monitors any change (e.g., decrease, increase) in the positioning RS signal measured RSRP/RSRPP values below or above a (pre) configured threshold; the WTRU observes a change on one or more of the positioning measurements over or below a (pre) configured threshold between two measurement occasions or over a defined period; the WTRU velocity exceeds a (pre) configured threshold; the WTRU measures an increase in ToA values above a (pre) configured threshold; the WTRU measures a doppler shift by a (pre) configured threshold; the WTRU monitors if RS is received in the configured time or not; the WTRU counts if retransmission requests is above a (pre) configured threshold; combinations of the same; or the like.

For example, the WTRU performing integrity assessment of positioning measurements includes at least one of monitoring if the maximum positioning error allowed by the application (e.g., known as alert limit) exceeds a preconfigured threshold; monitoring if the positioning error probability exceeds the alert limit; monitoring if the positioning error time to alert duration exceeds a preconfigured time threshold; combinations of the same; or the like.

In one example, the WTRU may determine one or more positioning measurements are unreliable. Also, for example, based on the WTRU determining one or more sensing measurements are unreliable, at least one of the following actions are performed: WTRU sends Uplink-Assistance Information to the network, e.g., indicate the cause (e.g., positioning not reliable), and/or error source, and/or actions performed, or the like; the WTRU may be configured to log “erroneous” positioning measurements mechanics; the WTRU may change what is reported in the measurement reports; the WTRU may decrease the granularity of positioning measurements; the WTRU requests updated positioning assistance information; the WTRU collects more measurements by increasing the positioning window; the WTRU may activate autonomously non-RAT positioning (e.g., using GPS); the WTRU may apply autonomously a different positioning configuration (e.g., base configuration); the WTRU may apply fusion of RAT based and non-RAT based positioning measurements; the WTRU may perform joint positioning method to improve positioning accuracy; the WTRU may activate and/or apply a new configuration for a second type (of dependent) measurement, e.g., sensing assisted positioning (e.g., a configuration could be associated to the characteristics of the problem, to identify error type and/or error source of problem); the WTRU may apply different positioning measurements granularity; the WTRU may apply different measurement quantity or methods; the WTRU may pause positioning for a (pre) defined time window that may depend on the positioning method; combinations of the same; or the like.

For example, regarding the WTRU configured to log “erroneous” positioning measurements mechanics, the WTRU may define start and/or stop time of logging window. Also, for example, the start and/or stop time of logging window may be defined in accordance with at least one of: in terms of symbol index, slot index, frame index, absolute time, relative time with respect to a reference point, or the like); the logging window duration may depend on the configured sensing task; the logging window duration may be configured by the NW; combinations of the same; or the like. Further, for example, regarding the WTRU configured to log “erroneous” sensing measurements mechanics, the WTRU may indicate what is logged (e.g., measurements, error type, error source, or the like). In addition, for example, the WTRU may indicate what actions are considered when logging is too long (e.g., multiple logging files, decrease the periodicity of measurements, or the like). Moreover, for example, the WTRU may indicate what actions are considered when logging stops (e.g., all measurements sent, buffer status report (BSR), or the like).

Also, for example, regarding the WTRU changing what is reported in the measurement reports, the WTRU may trigger some reports as a function of unreliable measurement conditions; and/or stop triggering other reports (e.g., if measurements are not useful).

In one example, the WTRU may perform a set of actions to improve positioning by triggering a sensing procedure and exploit sensing measurements. For example, the WTRU may apply at least one of the following actions: the WTRU may prioritize sensing over positioning procedure (e.g., pause and/or log positioning measurements, exploit sensing measurements that may allow satisfying positioning requirements then resume positioning); activate forward/backward scattering sensing procedures to determine if a target is blocking LOS path with supporting TRP and/or neighbor TRP(s); sense anchor objects as additional source of information; activate environmental object (EO) detection to reduce the interference; activate carrier aggregation to improve sensing resolution; suggests and/or activates and/or indicates to the network sensing configuration based on determined error source (e.g. if determined error source is angle based the WTRU may indicate to the NW sensing configuration with high angle resolution); activate single and multibounce sensing measurements; requests updated positioning assistance information that may include conditions for sensing; combinations of the same; or the like.

In one solution, the WTRU may trigger a sensing procedure if an LOS path is blocked to improve positioning. For example, the WTRU may perform at least one of the following: the WTRU may perform sensing to detect if the loss of the LOS path is due to a blockage or not; after detecting target blockage, the WTRU may use sensing measurements to detect the type of the target object (e.g., human, car, drone, or the like); the WTRU may figure out the expected time of blockage; the WTRU may utilize sensing measurements to estimate the expected range of values related to positioning (since the LOS path is typically the first detected in the CIR as the shortest path from Tx to Rx, the second path may serve as an upper bound for certain measurements, such as ToA, which allows for an expected value of the ToA for the LOS path, facilitating a coarse location estimate); the WTRU may trigger a sensing procedure to search for different supporting and/or neighbor TRPs to perform positioning measurements by avoiding paths that may overlap with objects detected by sensing procedure; combinations of the same; or the like.

In one solution, the WTRU may trigger a sensing procedure to improve channel responses for positioning RS (e.g., CIR or PDP), which might improve LOS detection and relevant positioning measurements accuracy. For example, the WTRU may perform at least one of the following: if the WTRU is performing sensing and positioning using one RS, the WTRU may use sensing measurements to assist the network in performing precoding to reinforce the LOS path while draining other paths to improve detection; if the WTRU is performing sensing and positioning using separate reference signals, the WTRU may use peaks detected in sensing CIR or PDP and compare it to the peaks detected in the responses for positioning, e.g., the WTRU will remove peaks below a preconfigured threshold as it may be considered as interference; the WTRU may keep the CIR peaks that are received within sensing measurements, e.g., ToA parameter, the range of ToA may be indicated using sensing measurements to indicate the maximum and minimum of acceptable peaks; combinations of the same; or the like.

In one solution the WTRU may use sensing measurements as an additional source of information to better estimate WTRU position. For example, the WTRU may perform at least one of the following: if fewer than three TRPs are available for triangulation, the WTRU can take angle measurements obtained using sensing anchor or reference objects with known locations and then integrate these measurements into the positioning method being used; if fewer than three TRPs are available for trilateration, the WTRU can take time measurements obtained using sensing anchor or reference objects with known locations and then integrate these measurements into the positioning method being used; no matter the number of TRPs, the WTRU may trigger a sensing procedure as an additional source of information to improve WTRU positioning accuracy, by integrating sensing measurements to positioning measurements; combinations of the same; or the like.

In one solution, the WTRU may prioritize sensing over positioning procedure. In one example, the WTRU may pause and/or positioning measurements, exploit sensing measurements to detect and/or resolve and/or assist in achieving requirements then resume positioning. In another example, the WTRU may use a shorter DRX cycle for sensing and a longer DRX cycle for positioning, which translates to more sensing measurements compared to positioning.

In one solution the WTRU may trigger sensing procedure to validate positioning measurements. For example, the WTRU may perform at least one of the following: the WTRU may perform joint error determination using sensing and positioning measurements; the WTRU may perform sensing measurements (AoA, ToA, or the like) from sensing reference units relative to estimated WTRU position, if the difference between what is measured and what is expected is less than a preconfigured threshold then positioning is valid, otherwise positioning is not valid; the WTRU may activate different sensing modes (e.g., switch from bistatic to monostatic by computing the target location (in monostatic) and comparing it to the location achieved in bistatic with respect to reference units); combinations of the same; or the like.

In one solution, the WTRU may trigger sensing procedure when the positioning assistance information is not valid and/or outdated and/or received. In one example, the WTRU may perform sensing to obtain sensing related information (e.g., environmental objects location, type, mobility, or the like) that may affect positioning measurements.

In one solution, the WTRU may trigger sensing configuration with specific parameters (e.g., using on-demand sensing request) based on determined positioning measurements error sources. For example, if a determined error source is an angle-based error source, the WTRU activates and/or initiates and/or triggers and/or indicates sensing configuration with high angular resolution. Also, for example, if a determined error source is a time-based error source, the WTRU activates and/or initiates and/or triggers and/or indicates sensing configuration with high time resolution.

In another example, the WTRU may determine one or more positioning measurements are reliable. For example, based on the WTRU determining one or more sensing measurements are reliable, at least one of the following actions are applied: WTRU may perform positioning procedure as normal including measurements, reporting, or the like; WTRU may increase reporting period; WTRU may decrease measurements and reporting; WTRU may perform subset of positioning measurements related to the positioning method; WTRU may extend the positioning assistance information validity window; WTRU may send the updated positioning validity window to the NW (e.g., LMF, SF, gNB); combinations of the same; or the like.

In another example, the WTRU may fail to achieve positioning requirements. For example, the WTRU may fail to achieve positioning requirements based on at least one of the following: positioning requirements are not satisfied after a preconfigured time window; no error type is determined; no error source is determined; multiple retransmission requests N over a preconfigured period; sensing cannot be triggered; the WTRU may terminate positioning and/or sensing procedures; the WTRU may request for reconfiguration for sensing and/or positioning; the WTRU may pause sensing and positioning for a predefined period; the WTRU may remove MeasID list (e.g., association between reporting config list and measurement object lists (e.g., sensing and/or positioning)); the WTRU may report all measurements and terminate; combinations of the same; or the like.

In one example, the WTRU may trigger a set of actions as a function of the determined sensing triggering positioning event (e.g., location-based triggers, QoS-based triggers, Mobility-based triggers, Time-based triggers, Event-based triggers, or the like).

In certain representative embodiments, WTRU reporting is provided. For example, the WTRU reporting includes at least one of WTRU reporting, one or more WTRU reporting updates, WTRU reporting termination, combinations of the same, or the like.

In one example, the WTRU performs positioning assisted sensing measurements and reports and/or sends and/or recommends to NW (e.g., gNB and/or LMF and/or sensing entity) a positioning assisted sensing report in periodic, aperiodic or semi-persistent from over an uplink control or data channel.

In one example, the WTRU may determine the report mode based on at least one of the following: reporting configuration, triggered event, determined error type, determined error source, NW entity that initiated the procedure, other defined parameters, combinations of the same, or the like.

In one example, the WTRU may determine the event of positioning assisted sensing. For example, the WTRU sends the positioning assisted sensing report to the NW. Also, for example, the WTRU is configured to additionally report its position to the network for additional processing (e.g., the position information may be required to estimate the absolute position of the target object as opposed to the relative location).

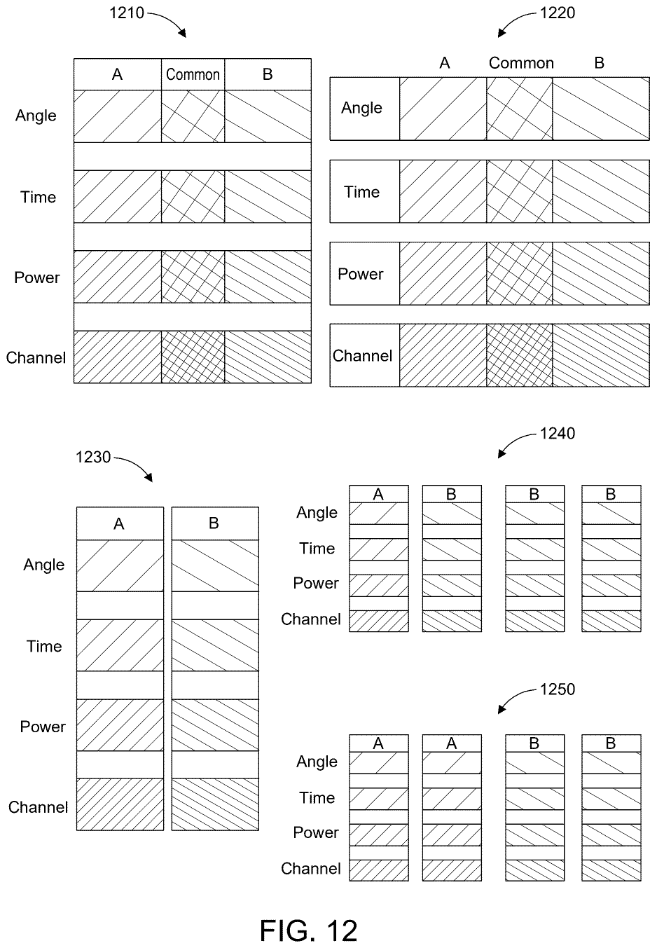

In one example, the WTRU may determine the event of positioning assisted sensing based on measurement type. For example, the WTRU sends the positioning assisted sensing report to the NW that may contain at least one of the following, as shown, for example, in FIG. 12: time measurements (e.g., sensing time measurements, positioning time measurements, common time measurements used for sensing and positioning, or the like); angle measurements (e.g., sensing angle measurements, positioning angle measurements, common angle measurements used for sensing and positioning, or the like); channel measurements (e.g., sensing channel measurements, positioning channel measurements, common channel measurements used for sensing and positioning, or the like); phase measurements (e.g., sensing phase measurements, positioning phase measurements, common phase measurements used for sensing and positioning, or the like); power measurements (e.g., sensing power measurements, positioning power measurements, common power measurements used for sensing and positioning, or the like); combinations of the same; or the like. Although phase measurements are not explicitly shown in FIG. 12, in some implementations, it is understood one or more phase measurements may be combined with any one of the one or more angle, time, power, and/or channel measurements in any suitable combination.

For example, in a first (e.g., sensing and/or positioning) reporting mode 1210, each of angle, time, power, and channel are measured using procedure A and using procedure B. Also, for example, common measurements of each of angle, time, power, and channel are performed.

For example, in a second (e.g., sensing and/or positioning) reporting mode 1220, each of angle, time, power, and channel are separately measured using procedure A and using procedure B. Also, for example, a common measurement for each of angle, time, power, and channel is separately performed.

For example, in a third (e.g., sensing and/or positioning) reporting mode 1230, each of angle, time, power, and channel are measured using procedure A. Also, for example, separately, each of angle, time, power, and channel are measured using procedure B. Further, for example, the reports of procedure A and procedure B are associated with each other.

For example, in a fourth (e.g., sensing and/or positioning) reporting mode 1240, a first report of procedure A is associated with first, second, and third reports of procedure B.

For example, in a fifth (e.g., sensing and/or positioning) reporting mode 1250, a first report of procedure A is associated with a second report of procedure A, a first report of procedure B, and a second report of procedure B.

In one example, the WTRU may trigger to report and/or indicate and/or include in the positioning assisted sensing report at least one of the following: sensing measurements associated with target object with uncertainties; positioning measurements with uncertainties; information not related to target object (e.g., total number of NLOS groups, average RSRP, or the like); the determined error type relevant to the performed measurements (e.g., systematic, random); the determined error source (e.g., angle error source, time error source, or the like); the error dependency type between hierarchal measurements (e.g., linear, non-linear); the WTRU and/or TRP timing error (e.g., WTRU reaction time to detect start and stop conditions of a timer, or the like); the measurement method used (e.g., absolute and/or relative); the activated and/or deactivated procedures performed (e.g., RAT, non-RAT positioning methods); measurement search window (e.g., length of the window, type, method used to calculate, start time of the window, or the like); the set of WTRU actions performed; combinations of the same; or the like.

In one example, the WTRU may report and/or suggest and/or recommend to the NW as a function of the determined triggering event at least one of the following: reconfiguration for sensing (e.g., if time-based error source is determined and random error type the WTRU requests and/or suggests and/or recommend increasing the BW); reconfiguration for positioning (e.g., if angle error source is determined the WTRU requests and/or suggests and/or recommend time-based positioning method); indicate termination of the procedure; indicate integrity failure or success; pause for sensing and/or positioning procedures and identify related information (e.g., defined time window, DRX cycle used, switch to RRC inactive state); stop reporting of sensing and/or positioning reports; change in report periodicity; combinations of the same; or the like.

In one example, the WTRU may report an association between sensing and positioning information at different granularity levels. For example, the WTRU reports an association between sensing and positioning information at different granularity levels, and does so retro-actively according to certain triggering conditions. Also, for example, sensing and positioning reporting comprises at least one of the following: reportConfig (RC), which contains reporting configuration list for sensing and/or positioning report IDs; measObject, which contains measurement object (MO) list for sensing and/or positioning MO IDs; measID list (e.g., one-to-one mapping between reportConfig list and measObject list); the WTRU may associate between one or more sensing report with one or more positioning report; the WTRU may associate one or more sensing measurement objects with one or more positioning measurement objects; the WTRU may associate the measurement objects (e.g., sensing and/or positioning) with one or more reporting configurations (e.g., sensing and/or positioning); the WTRU may associate measurement ID to one-to-one mapping between reporting configuration and measurement object lists; the WTRU may associate at least one of measurement IDs to a sensing task; combinations of the same; or the like.

In one example, the WTRU may report to the NW logging of errors for sensing and/or positioning mechanics. For example, the WTRU reports to the NW the logging of errors for sensing and/or positioning mechanics including at least one of the following: logging erroneous conditions (e.g., based on positioning and/or sensing conditions); logging erroneous duration (e.g., a logging time window or logging report number); logging erroneous actions performed (e.g., WTRU performs low periodicity for measurements, stops association between sensing and positioning measurements and/or information, or the like); logging erroneous resume actions performed (e.g., WTRU performs high periodicity for measurements, resume association between sensing and positioning, or the like); combinations of the same; or the like.

In one example, the WTRU sends the related measurements and reports to the relevant entity based on a reference signal configuration. In one example, the WTRU may send positioning measurements in addition to common measurements to the relevant positioning entity (e.g., LMF) mainly responsible for positioning. In one example, the WTRU may send sensing measurements in addition to common measurements to sensing entity (e.g., sensing entity, gNB, LMF) mainly responsible for sensing. In one example, the WTRU may send all measurements (e.g., sensing and positioning) to the positioning entity and/or sensing entity. In another example, the WTRU may send the report to the entity that initiated the procedure.

In one example, the WTRU may send the positioning assisted sensing measurement report over any configured uplink control or data channel. In another example, the WTRU may be configured to send each report mode on preconfigured uplink control or data channel based on the report type and/or triggering event type (e.g., report mode 1 sent over PUSCH, while report mode 2 over PUCCH).

In one solution, the measurement report may be transmitted through PUSCH, e.g., via RRC and/or MAC-CE through a configured scheduling mechanism (e.g., configured grant).

In one example, the WTRU may be configured to send decoding information (e.g., report format, type of content, allocated fields for each measurement, or the like) for the positioning assisted sensing measurement report on specific uplink control or data channel (e.g., the WTRU may send the decoding information of the report associated with sensing and positioning combination on the PUCCH). In another example, the gNB may blind-decode the received measurement sensing report from the WTRU. In one example, the WTRU may be configured to send its report to the network on a specific uplink control or data channel based on the measurement time granularity.

In another example, the WTRU may be configured to send its report to the network on a specific uplink control or data channel based on the report periodicity type (e.g., periodic, aperiodic, semi-persistent, or the like).

In some embodiments, WTRU reporting updates are provided. In one example, the WTRU may perform measurements on the RS reflected from the target location and/or WTRU location over multiple measurement occasions (e.g., multi-slot level, e.g., repetition factor, time gap configurations). The WTRU may determine that the target sensing task measurement report and/or WTRU positioning information may be invalid or outdated. For example, the WTRU may determine that the target sensing task measurement report and/or WTRU positioning information may be invalid or outdated based on at least one of the following: a change in any of the number of multipath components (MPCs), ToAs, AoAs, amplitudes or phases of the CIR peaks, or the like of any of the RS (e.g., sensing and/or positioning) above a threshold; an uncertainty in any of the characteristics of the CIR peaks above a threshold; a WTRU re-configuration message containing updated configuration parameters for reporting of positioning assisted sensing feedback; a change in the environment (e.g., change in the number of peaks in the CIR); an absolute or relative change in the WTRU coordinates, or the WTRU 3D orientation, or both, above a threshold; a time elapsed since the last reporting of positioning assisted sensing exceeding an absolute or relative duration (e.g., a configured periodicity); the change of WTRU location (e.g., moving outside a preconfigured geographical location, that may be changing in positioning measurements either from serving TRP or neighbor TRPs reflected change of one or more positioning-related measurements above or below a predefined threshold); the change of target location (e.g., target location outside a preconfigured sensing area, that may be changing in target sensing measurements reflected change of one or more positioning-related measurements above or below a predefined threshold); the change of error type determined; the change of error source determined; the change of triggering event conditions; the change of error measurement flow between dependent measurements; the change in the measured RS metric(s) and/or KPI(s) over a preconfigured threshold; receiving update request by other entity (e.g., gNB, LMF, SF); combinations of the same; or the like.

For example, based on any of the above, the WTRU may perform new positioning assisted sensing measurements. Also, for example, the WTRU determines to send an updated report in aperiodic, periodic or semi-persistent form over a UL control or data channel. Further, for example, the WTRU determines to send the updated target sensing task measurement report in aperiodic, periodic or semi-persistent form over the UL control or data channel containing at least one of the following: time stamp of the updated measurements (e.g., in absolute or relative time, or number of slots, frames, or the like relative to a known reference); updated antenna ports involved in the measurements; updated reference signal resources employed in the measurements; updated sensing measurements and uncertainties; updated positioning measurements and uncertainties; new set of sensing and/or positioning measurements with uncertainties; updated error types; updated error sources; updated dependency measurements effect; updated association between sensing and positioning measurement objects, measurement index, or reports; updated validity window; combinations of the same; or the like.

In another example, the WTRU may be configured to report the invalidity of its sensing and/or positioning measurement report and/or measurement object to the network.

In some embodiments, WTRU reporting termination is provided. For example, the WTRU reporting termination includes exit and/or failure and/or termination conditions. Also, for example, the WTRU is configured to perform the measurements over multiple measurement occasions (e.g., multi-slot level, e.g., repetition factor, time gap configurations). Further, for example, the WTRU determines that reporting the positioning assisted sensing measurements and information can be terminated. In addition, for example, a determination, by the WTRU, that reporting the sensing assisted positioning measurements and information is to be terminated is based on at least one of the following: the determination of no change in one or more of the sensing and positioning measurements over a predefined period; the determination of no change in one or more of the positioning measures over a predefined period; the determination of no change in error types over a predefined period; the determination of no change in error sources over a predefined period; the determination of no change in one or more of the metrics or KPIs over a predefined period; achieving the positioning requirements over a predefined period; a time elapsed since the last reporting of precoding feedback information exceeding a maximum absolute or relative duration; the determination of sensing error in one or more related positioning measurements below or above a preconfigured threshold for a configured threshold time or configured number of measurement occasions; the determination of positioning error in one or more related positioning measurements below or above a preconfigured threshold for a configured threshold time or configured number of measurement occasions; a low-battery indication by the WTRU; a termination indication by the network; combinations of the same; or the like.

In a solution, based on any of the above, the WTRU may terminate the procedure of positioning assisted sensing and may send a report over a UL control or data channel containing the recommendation to terminate the measurement procedure. Also, for example, the WTRU may terminate the procedure and send the report including at least one of the following: termination indicator, termination time stamp, detailed termination reason, the latest sensing assisted positioning report, combinations of the same, or the like.

In one example, the termination indicator may refer to the reason of termination. For example, termination indicator=1 refers to error type does not change for N measurement occasions. While an indicator value=2 refers to determined error source for N measurement occasions.

Regarding the detailed termination reason, in one example, the WTRU may terminate the procedure and send the report including the number of scatterers in the first set whose absolute or relative power, or SNR, is below the minimum configured threshold for the reporting conditions, or the like.

Also, for example, the latest positioning assisted sensing report includes at least one of requested information, measurements performed, determined error types, determined error sources, existing triggering conditions, WTRU actions performed, time stamps, RS signal ID used for sensing, RS signal ID used for positioning, combinations of the same, or the like.

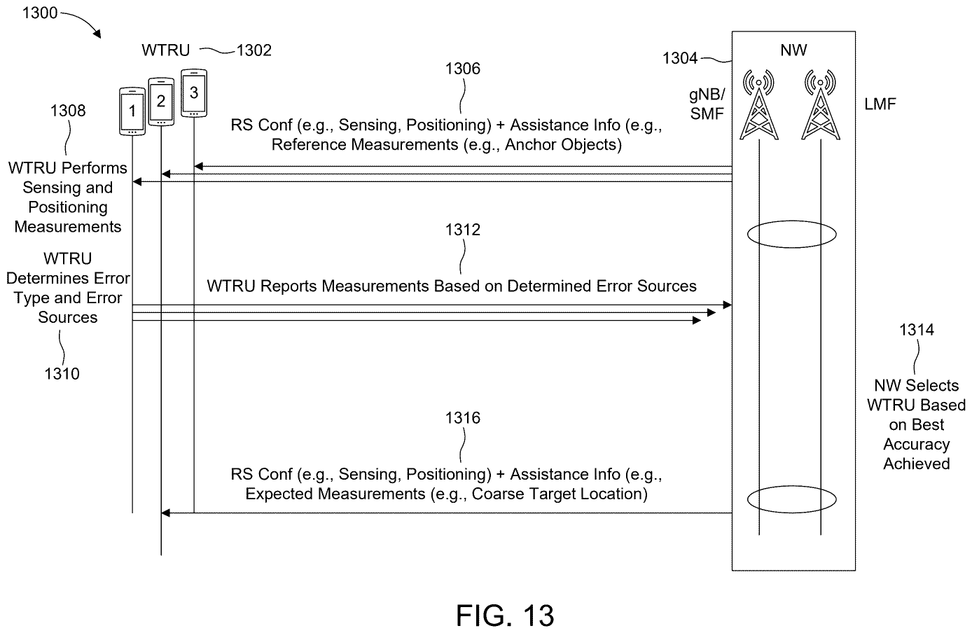

In certain representative embodiments, sensing measurement and/or error type and/or source determination are provided. FIG. 13 is a flowchart of a sensing assisted positioning procedure 1300 using multi-WTRU scenarios and separate NW entities to perform sensing and positioning. For example, the procedure 1300 involves one or more WTRUs 1302, or the like. Also, for example, the procedure 1300 involves NW 1304. Further, for example, the NW 1304 includes gNB/SMF and/or LMF. In addition, for example, the procedure 1300 includes transmitting 1306 an RS configuration (e.g., sensing, positioning, and the like) from the NW 1304 to at least one of the WTRUs 1302. Moreover, for example, the transmitting 1306 includes assistance information (e.g., reference measurements (e.g., anchor objects)). In the example of FIG. 13, each of three WTRUs 1302 receives the RS configuration.

Also, for example, the procedure 1300 includes, at each of the WTRUs 1302, performing 1308 one or more sensing and/or positioning measurements. Further, for example, the procedure 1300 includes, at each of the WTRUs 1302, determining 1310 one or more error types and/or one or more error sources. In addition, for example, the procedure 1300 includes, from each of the WTRUs 1302, transmitting 1312 one or more WTRU report measurements to the network 1304. Moreover, for example, the procedure 1300 includes selecting 1314, at the network 1304, at least one (e.g., or a set, or all) of the WTRUs 1302 based on an attribute, e.g., a preconfigured attribute such as a best accuracy achieved. Furthermore, for example, the procedure 1300 includes transmitting 1316 a revised RS configuration (e.g., sensing, positioning, and the like) from the NW 1304 to at least one of the WTRUs 1302. Additionally, for example, the transmitting 1316 includes assistance information (e.g., expected measurements (e.g., coarse target location)). In the example of FIG. 13, a selected one of three WTRUs 1302 (e.g., the WTRU achieving the best accuracy) receives the revised RS configuration.

The procedure 1300 provides, for example, reliable sensing measurement and/or error type and/or source determination. Also, for example, the procedure 1300 provides prioritization conditions between different procedures (e.g., sensing procedure, positioning procedure).

Numerous benefits are achieved by the methods and systems disclosed herein. The benefits include but are not limited to at least one of improved QoS, improved power savings, improved reporting overhead, enablement of new use cases for positioning and/or sensing, combinations of the same, or the like.

For example, improved QoS is provided (e.g., sensing and/or positioning) achieving higher accuracy by detecting and resolving error types and sources.

Regarding the improved power saving, for example, additional benefits include an ability to not process sensing unless provided for reporting of positioning measurements, and/or an ability to not send measurements that are not useful. Also, for example, the WTRU performs sensing related to positioning only when positioning is in a specific state, or a signaling optimization. Further, for example, the WTRU can autonomously control how it performs sensing based on a positioning process avoiding providing for the NW to explicitly control and/or activate (or the like) the positioning and sensing configuration.

Regarding the improved reporting overhead over the NW, for example, useful measurements are sent by determining if the WTRU measurements are reliable or not.

For example, the new use cases are enabled that rely on sensing and/or positioning.

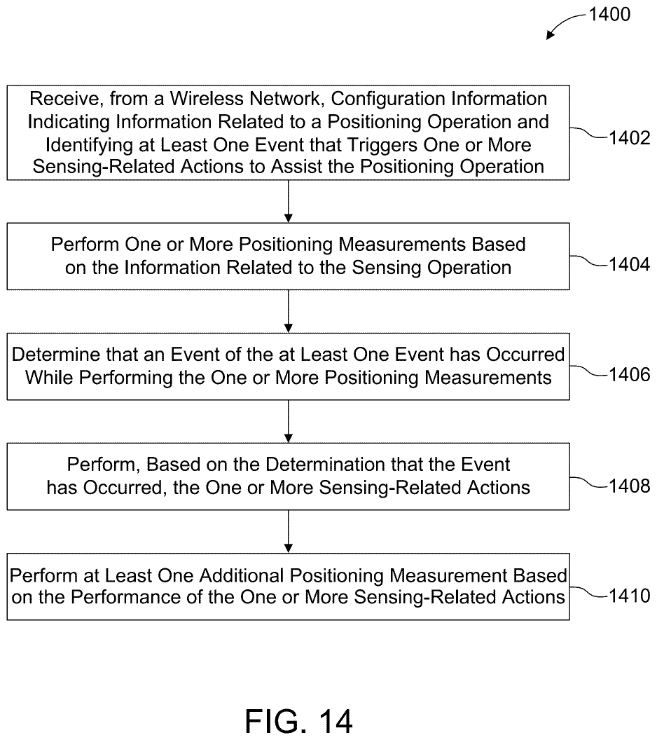

In certain representative embodiments, as shown, for example, in FIG. 14, a WTRU (e.g., 102, 202, 302, 402, 502, 602, 702, 802, 1302, or the like) is provided in communication with a wireless network (e.g., core network 106, 115; TRP 204; network 304, 406, 408, 504; gNB 604; TRP 704, 804; network 1304; or the like). For example, a method 1400 is performed by the WTRU. Also, for example, the method 1400 comprises receiving 1402, from the wireless network, configuration information indicating information related to a positioning operation and identifying at least one event that triggers one or more sensing-related actions to assist the positioning operation. Further, for example, the method 1400 comprises performing 1404 one or more positioning measurements based on the information related to the positioning operation. In addition, for example, for example, the method 1400 comprises determining 1406 that an event of the at least one event has occurred while performing the one or more positioning measurements. Moreover, for example, the method 1400 comprises performing 1408, based on the determination that the event has occurred, the one or more sensing-related actions. Furthermore, for example, the method 1400 comprises performing 1410 at least one additional positioning measurement based on the performance of the one or more sensing-related actions.

Also, for example, the event is based on at least one of: changes in the one or more positioning measurements; hierarchical measurement dependencies; a determined error type or error source; reference values or expected values of the one or more positioning measurements; reliability of the one or more positioning measurements; a lack of neighboring cells; a loss of line of sight; variation in channel impulse response; one or more positioning requirements not being satisfied; or mobility of the WTRU.

Further, for example, the information related to the positioning operation comprises at least one of: a target identifier; target positioning information; a target type; target mobility information; WTRU positioning information; hierarchical measurements and dependencies; error sources, types, groups, or determination procedures; reference positioning measurements; thresholds for measurement validation; reporting assistance information; or a validity time.

In addition, for example, the method 1400 comprises transmitting, to the wireless network, assistance information based at least in part on the one or more positioning measurements. Moreover, for example, the method 1400 comprises receiving, from the wireless network, updated configuration information. Furthermore, for example, the method 1400 comprises repeating the first performing step 1404, the determining step 1406, the second performing step 1408, the third performing step 1410, the transmitting step (i.e., the transmitting, to the wireless network, assistance information based at least in part on the one or more positioning measurements), and the receiving step (i.e., the receiving, from the wireless network, updated configuration information) based on determining that a termination event does not exist. Additionally, for example, the method 1400 comprises transmitting, to the wireless network, a report based on the one or more positioning measurements based on determining that the termination event exists.

Still further, for example, the one or more sensing-related actions comprise at least one of: identifying an alternate path or reference signal to measure; estimating expected duration of an error state; estimating and reporting, to the wireless network, a position of the WTRU; improving line of sight detection and clutter removal; performing one or more sensing measurements; validating the one or more sensing measurements and determining a validity window; reporting of the one or more sensing measurements based on measurement validation; or determining reporting modes of the one or more sensing measurements based on the event.

Even further, for example, based on the event further triggering one or more positioning-related actions to assist the positioning operation, the method 1400 further comprises performing, based on the determination that the event has occurred, the one or more positioning-related actions. Yet further, for example, based on the event further triggering one or more positioning-related actions to assist the positioning operation, the method 1400 further comprises performing the at least one additional positioning measurement based on the performance of the one or more positioning-related actions.

Yet further, for example, the one or more positioning-related actions comprise at least one of: sending uplink assistance information to the wireless network; logging a first set of positioning measurements; stopping radio access technology (RAT) based positioning; applying non-RAT based positioning; enabling a second set of positioning measurements; validating the first set of positioning measurements and determining a validity window; reporting of the first set of positioning measurements based on measurement validation; or determining reporting modes of the first set of positioning measurements based on the additional event.

Also, for example, based on the configuration information further indicating information related to a sensing operation, the method 1400 further comprises performing one or more sensing measurements based on the information related to the sensing operation.

Further, for example, the determining that the event of the at least one event has occurred is based on the one or more sensing measurements.

In addition, for example, based on the configuration information further identifying an additional at least one event that triggers one or more sensing-related actions to assist the positioning operation, the method 1400 further comprises receiving, from the wireless network, updated configuration information indicating updated information related to the positioning operation. Moreover, for example, the performing the at least one additional positioning measurement is further based on the updated information related to the positioning operation.

In some embodiments, a WTRU (e.g., 102, 202, 302, 402, 502, 602, 702, 802, 1302, or the like) is configured to perform any combination of the above-referenced steps of the method 1400.

In certain representative embodiments, a wireless network (e.g., core network 106, 115; TRP 204; network 304, 406, 408, 504; gNB 604; TRP 704, 804; network 1304; or the like) communicates with a WTRU (e.g., 102, 202, 302, 402, 502, 602, 702, 802, 1302, or the like). The wireless network sends configuration information to the WTRU, indicating details related to a positioning operation and identifying events that trigger sensing-related actions to assist the positioning operation. The wireless network receives positioning measurements from the WTRU and determines if any predefined events have occurred during these measurements. Upon detecting an event, the wireless network instructs the WTRU to perform specific sensing-related actions, such as identifying alternate paths or reference signals, estimating error durations, and improving line of sight detection. The wireless network directs the WTRU to perform additional positioning measurements based on the sensing-related actions. The wireless network receives assistance information from the WTRU, which is based on the positioning measurements. The wireless network provides updated configuration information to the WTRU, as necessary. The wireless network continues to repeat the measurement, event detection, and sensing-related actions until a termination event is identified. If a termination event occurs, the wireless network receives a final report from the WTRU. The wireless network manages both sensing and positioning operations, ensuring that the WTRU performs necessary measurements and actions based on updated configuration information and detected events. The wireless network validates the measurements and determines reporting modes based on the events and the validity of the measurements.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving, from a wireless network, configuration information indicating information related to a positioning operation and identifying at least one event that triggers one or more sensing-related actions to assist the positioning operation;
performing one or more positioning measurements based on the information related to the positioning operation;
determining that an event of the at least one event has occurred while performing the one or more positioning measurements;
performing, based on the determination that the event has occurred, the one or more sensing-related actions; and
performing at least one additional positioning measurement based on the performance of the one or more sensing-related actions.

2. The method of claim 1, wherein the event is based on at least one of:
changes in the one or more positioning measurements;
hierarchical measurement dependencies;
a determined error type or error source;
reference values or expected values of the one or more positioning measurements;
reliability of the one or more positioning measurements;
a lack of neighboring cells;
a loss of line of sight;
variation in channel impulse response;
one or more positioning requirements not being satisfied; or
mobility of the WTRU.

3. The method of claim 1, wherein the information related to the positioning operation comprises at least one of:
a target identifier;
target positioning information;
a target type;
target mobility information;
WTRU positioning information;
hierarchical measurements and dependencies;
error sources, types, groups, or determination procedures;
reference positioning measurements;
thresholds for measurement validation;
reporting assistance information; or
a validity time.

4. The method of claim 1, further comprising:
transmitting, to the wireless network, assistance information based at least in part on the one or more positioning measurements;
receiving, from the wireless network, updated configuration information;
repeating the performing one or more positioning measurements based on the information related to the positioning operation, the determining that an event of the at least one event has occurred while performing the one or more positioning measurements, the performing, based on the determination that the event has occurred, the one or more sensing-related actions, the performing at least one additional sensing measurement based on the performance of the one or more sensing-related actions, the transmitting, to the wireless network, assistance information based at least in part on the one or more positioning measurements, and the receiving, from the wireless network, updated configuration information based on determining that a termination event does not exist; and
transmitting, to the wireless network, a report based on the one or more positioning measurements based on determining that the termination event exists.

5. The method of claim 1, wherein the one or more sensing-related actions comprise at least one of:
identifying an alternate path or reference signal to measure;
estimating expected duration of an error state;
estimating and reporting, to the wireless network, a position of the WTRU;
improving line of sight detection and clutter removal;
performing one or more sensing measurements;
validating the one or more sensing measurements and determining a validity window;
reporting of the one or more sensing measurements based on measurement validation; or
determining reporting modes of the one or more sensing measurements based on the event.

6. The method of claim 1, wherein the event further triggers one or more positioning-related actions to assist the positioning operation, further comprising:
performing, based on the determination that the event has occurred, the one or more positioning-related actions; and
performing the at least one additional positioning measurement based on the performance of the one or more positioning-related actions.

7. The method of claim 6, wherein the one or more positioning-related actions comprise at least one of:
sending uplink assistance information to the wireless network;
logging a first set of positioning measurements;
stopping radio access technology (RAT) based positioning;
applying non-RAT based positioning;
enabling a second set of positioning measurements;
validating the first set of positioning measurements and determining a validity window;
reporting of the first set of positioning measurements based on measurement validation; or
determining reporting modes of the first set of positioning measurements based on the additional event.

8. The method of claim 1, wherein the configuration information further indicates information related to a sensing operation, further comprising:
performing one or more sensing measurements based on the information related to the sensing operation.

9. The method of claim 8, wherein the determining that the event of the at least one event has occurred is based on the one or more sensing measurements.

10. The method of claim 1, further comprising:
receiving, from the wireless network, updated configuration information indicating updated information related to the positioning operation; and
wherein the performing the at least one additional positioning measurement is further based on the updated information related to the positioning operation.

11. A wireless transmit/receive unit (WTRU) comprising:
a processor; and
a transceiver, wherein the WTRU is configured to:
receive, from a wireless network, configuration information indicating information related to a positioning operation and identifying at least one event that triggers one or more sensing-related actions to assist the positioning operation;
perform one or more positioning measurements based on the information related to the positioning operation;
determine that an event of the at least one event has occurred while performing the one or more positioning measurements;
perform, based on the determination that the event has occurred, the one or more sensing-related actions; and
perform at least one additional sensing measurement based on the performance of the one or more sensing-related actions.

12. The WTRU of claim 11, wherein the event is based on at least one of:
changes in the one or more positioning measurements;
hierarchical measurement dependencies;
a determined error type or error source;
reference values or expected values of the one or more positioning measurements;
reliability of the one or more positioning measurements;
a lack of neighboring cells;
a loss of line of sight;
variation in channel impulse response;
one or more positioning requirements not being satisfied; or
mobility of the WTRU.

13. The WTRU of claim 11, wherein the information related to the positioning operation comprises at least one of:
a target identifier;
target positioning information;
a target type;
target mobility information;
WTRU positioning information;
hierarchical measurements and dependencies;
error sources, types, groups, or determination procedures;
reference positioning measurements;
thresholds for measurement validation;
reporting assistance information; or
a validity time.

14. The WTRU of claim 11, wherein the WTRU is further configured to:
transmit, to the wireless network, assistance information based at least in part on the one or more positioning measurements;
receive, from the wireless network, updated configuration information;
repeat the performing one or more positioning measurements based on the information related to the positioning operation, the determining that an event of the at least one event has occurred while performing the one or more positioning measurements, the performing, based on the determination that the event has occurred, the one or more sensing-related actions, the performing at least one additional sensing measurement based on the performance of the one or more sensing-related actions, the transmitting, to the wireless network, assistance information based at least in part on the one or more positioning measurements, and the receiving, from the wireless network, updated configuration information based on determining that a termination event does not exist; and
transmit, to the wireless network, a report based on the one or more positioning measurements based on determining that the termination event exists.

15. The WTRU of claim 11, wherein the one or more sensing-related actions comprise at least one of:
identifying an alternate path or reference signal to measure;
estimating expected duration of an error state;
estimating and reporting, to the wireless network, a position of the WTRU;
improving line of sight detection and clutter removal;
performing one or more sensing measurements;
validating the one or more sensing measurements and determining a validity window;
reporting of the one or more sensing measurements based on measurement validation; or
determining reporting modes of the one or more sensing measurements based on the event.

16. The WTRU of claim 11, wherein the event further triggers one or more positioning-related actions to assist the positioning operation, and wherein the WTRU is further configured to:
perform, based on the determination that the event has occurred, the one or more positioning-related actions; and
perform the at least one additional positioning measurement based on the performance of the one or more positioning-related actions.

17. The WTRU of claim 16, wherein the one or more positioning-related actions comprise at least one of:
sending uplink assistance information to the wireless network;
logging a first set of positioning measurements;
stopping radio access technology (RAT) based positioning;
applying non-RAT based positioning;
enabling a second set of positioning measurements;
validating the first set of positioning measurements and determining a validity window;
reporting of the first set of positioning measurements based on measurement validation; or
determining reporting modes of the first set of positioning measurements based on the additional event.

18. The WTRU of claim 11, wherein the configuration information further indicates information related to a sensing operation, and wherein the WTRU is further configured to:
perform one or more sensing measurements based on the information related to the sensing operation.

19. The WTRU of claim 18, wherein the WTRU configured to determine that the event of the at least one event has occurred is based on the one or more sensing measurements.

20. The WTRU of claim 11, wherein the WTRU is further configured to:
receive, from the wireless network, updated configuration information indicating updated information related to the positioning operation; and
wherein the performing the at least one additional positioning measurement is further based on the updated information related to the positioning operation.
